(19) United States
(12) Patent Application Publication
(10) Pub. No.: US 2026/0322472 A1
(43) Pub. Date: Oct. 15, 2026

(54) GENERATIVE MODELS FOR GENERATING PERFORMANCE TEST DATA FOR USER EQUIPMENT SIDE BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/485,450

(22) PCT Filed: Aug. 2, 2023
(86) PCT No.: PCT/CN2023/110670

§ 371 Date: Nov. 18, 2025

(51) Int. Cl. H04B 7/06; G06N 20/00; H04B 17/318; H04B 17/336

(52) U.S. Cl. CPC H04B 7/06968; G06N 20/00; H04B 17/328; H04B 17/336

(57) ABSTRACT

Various aspects of the present disclosure generally relate to wireless communication. In some aspects, a test equipment (TE) may transmit a layer 1 (L1) reference signal received power (RSRP) or L1 signal-to-interference-plus-noise ratio (SINR) (LI-RSRP/L1-SINR) measurements associated with a first set of resources, wherein the L1-RSRP/L1-SINR measurements associated with the first set of resources are based at least in part on a generative model for test data that uses a randomization parameter. The TE may receive, based at least in part on the L1-RSRP/L1-SINR measurements associated with the first set of resources, a beam prediction feedback associated with a user equipment (UE)-side beam prediction, wherein the beam prediction feedback indicates L1-RSRP/L1-SINR measurements associated with a second set of resources. Numerous other aspects are described.

### INTRODUCTION

Aspects of the present disclosure generally relate to wireless communication and to techniques and apparatuses for models for generating test data for beam prediction.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a test equipment (TE). The apparatus may include one or more memories and one or more processors coupled to the one or more memories. The one or more processors may be configured to cause the TE to transmit layer 1 (L1) reference signal received power (RSRP) or L1 signal-to-interference-plus-noise ratio (SINR) (L1-RSRP/L1-SINR) measurements associated with a first set of resources, wherein the L1-RSRP/L1-SINR measurements associated with the first set of resources are based at least in part on a generative model for test data that uses a randomization parameter. The one or more processors may be configured to cause the TE to receive, based at least in part on the L1-RSRP/L1-SINR measurements associated with the first set of resources, a beam prediction feedback associated with a user equipment (UE)-side beam prediction, wherein the beam prediction feedback indicates L1-RSRP/L1-SINR measurements associated with a second set of resources.

Some aspects described herein relate to an apparatus for wireless communication at a UE. The apparatus may include one or more memories and one or more processors coupled to the one or more memories. The one or more processors may be configured to cause the UE to receive L1-RSRP/L1-SINR measurements associated with a first set of resources, wherein the L1-RSRP/L1-SINR measurements associated with the first set of resources are based at least in part on a generative model for test data that uses a randomization parameter. The one or more processors may be configured to cause the UE to transmit, based at least in part on the L1-RSRP/L1-SINR measurements associated with the first set of resources, a beam prediction feedback indicating L1-RSRP/L1-SINR measurements associated with a second set of resources.

Some aspects described herein relate to a method of wireless communication performed at a TE. The method may include transmitting L1-RSRP/L1-SINR measurements associated with a first set of resources, wherein the L1-RSRP/L1-SINR measurements associated with the first set of resources are based at least in part on a generative model for test data that uses a randomization parameter. The method may include receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources.

Some aspects described herein relate to a method of wireless communication performed at a UE. The method may include receiving L1-RSRP/L1-SINR measurements associated with a first set of resources, wherein the L1-RSRP/L1-SINR measurements associated with the first set of resources are based at least in part on a generative model for test data that uses a randomization parameter. The method may include transmitting, based at least in part on the L1-RSRP/L1-SINR measurements associated with the first set of resources, a beam prediction feedback indicating L1-RSRP/L1-SINR measurements associated with a second set of resources.

Some aspects described herein relate to a non-transitory computer-readable medium that stores a set of instructions for wireless communication by a TE. The set of instructions, when executed by one or more processors of the TE, may cause the TE to transmit L1-RSRP/L1-SINR measurements associated with a first set of resources, wherein the L1-RSRP/L1-SINR measurements associated with the first set of resources are based at least in part on a generative model for test data that uses a randomization parameter. The set of instructions, when executed by one or more processors of the TE, may cause the TE to receive, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources.

Some aspects described herein relate to a non-transitory computer-readable medium that stores a set of instructions for wireless communication by a UE. The set of instructions, when executed by one or more processors of the UE, may cause the UE to receive L1-RSRP/L1-SINR measurements associated with a first set of resources, wherein the L1-RSRP/L1-SINR measurements associated with the first set of resources are based at least in part on a generative model for test data that uses a randomization parameter. The set of instructions, when executed by one or more processors of the UE, may cause the UE to transmit, based at least in part on the L1-RSRP/L1-SINR measurements associated with the first set of resources, a beam prediction feedback indicating L1-RSRP/L1-SINR measurements associated with a second set of resources.

Some aspects described herein relate to an apparatus for wireless communication. The apparatus may include means for transmitting L1-RSRP/L1-SINR measurements associated with a first set of resources, wherein the L1-RSRP/L1-SINR measurements associated with the first set of resources are based at least in part on a generative model for test data that uses a randomization parameter. The apparatus may include means for receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources.

Some aspects described herein relate to an apparatus for wireless communication. The apparatus may include means for receiving L1-RSRP/L1-SINR measurements associated with a first set of resources, wherein the L1-RSRP/L1-SINR measurements associated with the first set of resources are based at least in part on a generative model for test data that uses a randomization parameter. The apparatus may include means for transmitting, based at least in part on the L1-RSRP/L1-SINR measurements associated with the first set of resources, a beam prediction feedback indicating L1-RSRP/L1-SINR measurements associated with a second set of resources.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of beam management, in accordance with the present disclosure.

FIGS. 5-8 are diagrams illustrating examples associated with generative models for generating performance test data for UE-side beam prediction, in accordance with the present disclosure.

FIGS. 9-10 are diagrams illustrating example processes associated with generative models for generating performance test data for UE-side beam prediction, in accordance with the present disclosure.

FIG. 11 is a diagram of an example apparatus for wireless communication, in accordance with the present disclosure.

FIG. 12 is a diagram illustrating an example of a hardware implementation for an apparatus employing a processing system, in accordance with the present disclosure.

FIG. 13 is a diagram illustrating an example implementation of code and circuitry for an apparatus, in accordance with the present disclosure.

FIG. 14 is a diagram of an example apparatus for wireless communication, in accordance with the present disclosure.

FIG. 15 is a diagram illustrating an example of a hardware implementation for an apparatus employing a processing system, in accordance with the present disclosure.

FIG. 16 is a diagram illustrating an example implementation of code and circuitry for an apparatus, in accordance with the present disclosure.

FIGS. 17A and 17B are diagrams illustrating examples of machine learning (ML) models for beam prediction, in accordance with the present disclosure.

### DETAILED DESCRIPTION

A user equipment (UE) may be configured to perform a UE-side beam prediction. The UE, based at least in part on the UE-side beam prediction, may use historical beam measurement results of past UE beams to determine predicted beam measurements for upcoming occasions. The UE-side beam prediction may involve determining the predicted beam measurements for the upcoming occasions. According to one example, the UE may run a UE-side artificial intelligence and/or machine learning (AI/ML) model for the UE-side beam prediction. The UE may use performance testing to evaluate an accuracy of the UE-side beam prediction. The UE-side beam prediction may be evaluated across different operating scenarios and/or environments. The different operating scenarios and/or environments may include indoor/outdoor environments, large/small delay spread scenarios, and/or high/low Doppler shift scenarios.

Performance testing, which may involve testing a performance level of the UE-side beam prediction, may typically be done using over the air (OTA) testing. In OTA testing, a test equipment (TE) may transmit, to the UE and via an air interface, historical beam measurements. The UE may determine, using the UE-side beam prediction, predicted beam measurements for upcoming occasions based at least in part on the historical beam measurements. The predicted beam measurements may be derived using the historical beam measurements. The TE, which may store true beam measurements associated with the historical beam measurements, may compare the predicted beam measurements and the true beam measurements in order to evaluate an accuracy of the UE-side beam prediction.

However, performing testing for UE-side beam prediction using OTA testing (or an OTA setup) may not be ideal. When evaluating the accuracy of the UE-side beam prediction using OTA testing, generating various scenarios and/or environments associated with indoor/outdoor, large/small delay spread, and/or high/low Doppler shift may be relatively complex. In the OTA setup, such various scenarios and/or environments may be unable to be simulated, which may result in the UE-side beam prediction being inadequately evaluated for the UE. Performance testing using OTA may not verify the accuracy of the UE-side beam prediction when faced with the various scenarios and/or environments. As a result, UE-side beam prediction may be inadequately tested, and a relatively inaccurate UE-side beam prediction may be used, thereby degrading an overall performance of the UE.

Further, with OTA testing, the historical measurements provided by the TE to the UE may be relatively non-complex due to the bandwidth limitations of OTA testing. The UE may be able to determine (or predetermine) measurements to be provided by the TE. The AI/ML model may be trained based at least in part on the predetermined measurements, so the UE may be able to generate relatively accurate predicted beam measurements. However, the AI/ML model may not be adequately trained using other measurements. The TE, when receiving the relatively accurate predicted beam measurements from the UE, may incorrectly determine that the UE-side beam prediction is relatively accurate. In other words, by having prior information regarding the measurements to be provided by the TE, the UE may “cheat” on the UE-side beam prediction, and as a result, the TE may improperly evaluate the accuracy of the UE-side beam prediction.

Additionally, or alternatively, in some aspects described herein, the TE may use a generative model for test data to generate measurements. The generative model for test data may be an AI/ML model. The measurements may include layer 1 (L1) reference signal received power (RSRP) or L1 signal-to-interference-plus-noise ratio (SINR) (L1-RSRP/L1-SINR) measurements. The measurements may be associated with a first set of resources. The first set of resources may be synchronization signal blocks (SSBs) and/or channel state information reference signals (CSI-RSs). The generative model may use randomization parameters when generating the test data. The randomization parameters may be associated with a network node antenna configuration, a delay spread, an indoor environment, an outdoor environment, an urban environment, a rural environment, a cell type, a Doppler shift, and/or a UE speed. The randomization parameters may be used to generate the test data for various scenarios and/or environments, where the randomization parameters may prevent the UE from having prior information regarding the measurements to be provided by the UE. The TE may transmit the measurements to a UE via a cable connecting the TE and the UE. The UE may transmit, to the TE, a beam prediction feedback that includes predicted beam measurements, which may be based at least in part on the measurements transmitted by the TE. The TE may evaluate an accuracy of a UE-side beam prediction based at least in part on the predicted beam measurements.

In some aspects, by implementing performance testing for UE-side beam prediction using the generative model for test data, an accuracy of the UE-side beam prediction may be evaluated, without relying on OTA testing. The generative model for test data may be able to simulate different operating scenarios and/or environments associated with indoor/outdoor, large/small delay spread, and/or high/low Doppler shift. The performance testing for UE-side beam prediction using the generative model for test data and the conducted performance test may result in an adequate testing of the UE-side beam prediction, which may prevent relatively inaccurate UE-side beam prediction from being used, thereby improving an overall performance of the UE.

In some aspects, when the test data is generated using the generative model for test data, the test data may be randomly generated for the different operating scenarios and/or environments (e.g., using the randomization parameters). Due to the relatively large number of possible values for the test data, the UE may be less likely to be aware of the contents of the test data, and thus, the UE may be less likely to “cheat” on the performance testing. When the generative model is used to generate the test data using the randomization parameters, the UE may be less likely to be aware of the contents of the test data, so beam prediction feedback based at least in part on the test data may be a more reliable reflection of the accuracy of the UE-side beam prediction. For example, when the UE-side beam prediction is of relatively poor accuracy, the UE may be unable to produce favorable beam prediction feedback by already having information regarding the contents of the test data. The performance testing may not mistakenly indicate that the UE-side beam prediction is relatively accurate when not true. By having information regarding a true accuracy of the UE-side beam prediction, an overall system performance may be improved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

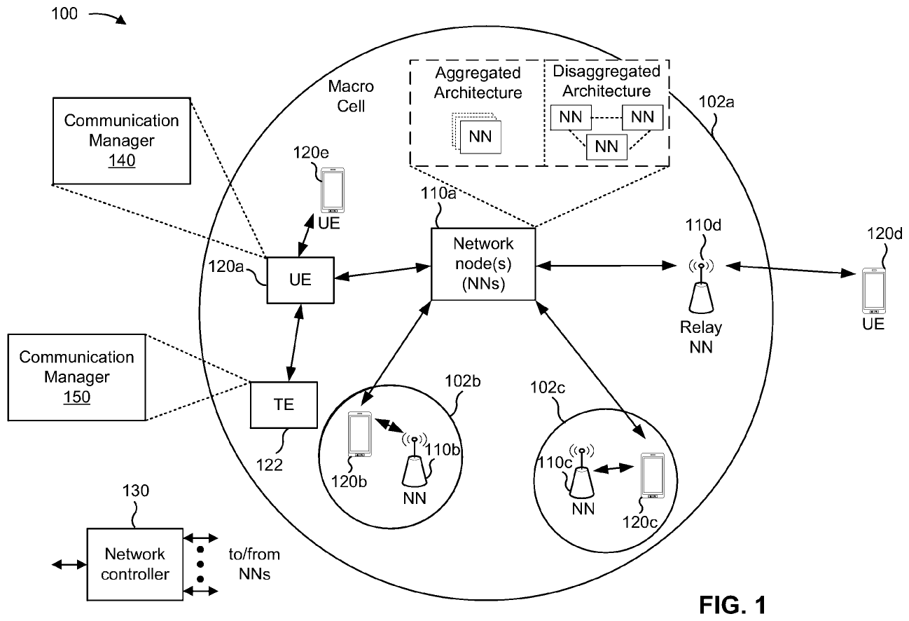

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a TE (e.g., TE 122) may include a communication manager 150. As described in more detail elsewhere herein, the communication manager 150 may transmit L1-RSRP/L1-SINR measurements associated with a first set of resources, wherein the L1-RSRP/L1-SINR measurements associated with the first set of resources are based at least in part on a generative model for test data that uses a randomization parameter; and receive, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources. Additionally, or alternatively, the communication manager 150 may perform one or more other operations described herein.

In some aspects, a UE (e.g., UE 120) may include a communication manager 140. As described in more detail elsewhere herein, the communication manager 140 may receive L1-RSRP/L1-SINR measurements associated with a first set of resources, wherein the L1-RSRP/L1-SINR measurements associated with the first set of resources are based at least in part on a generative model for test data that uses a randomization parameter; and transmit, based at least in part on the L1-RSRP/L1-SINR measurements associated with the first set of resources, a beam prediction feedback indicating L1-RSRP/L1-SINR measurements associated with a second set of resources. Additionally, or alternatively, the communication manager 140 may perform one or more other operations described herein.

As indicated above, FIG. 1 is provided as an example. Other examples may differ from what is described with regard to FIG. 1.

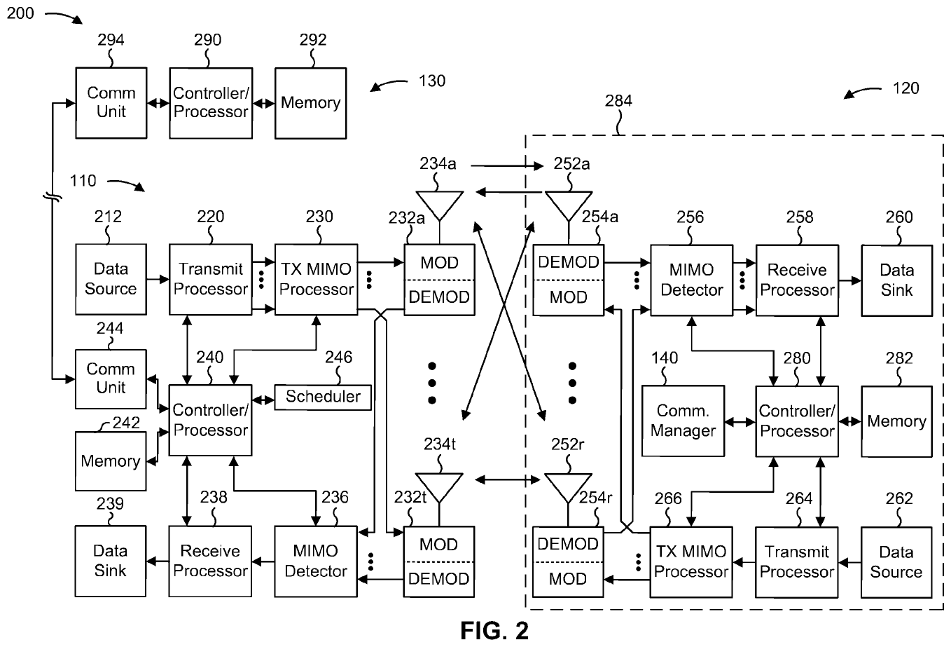

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

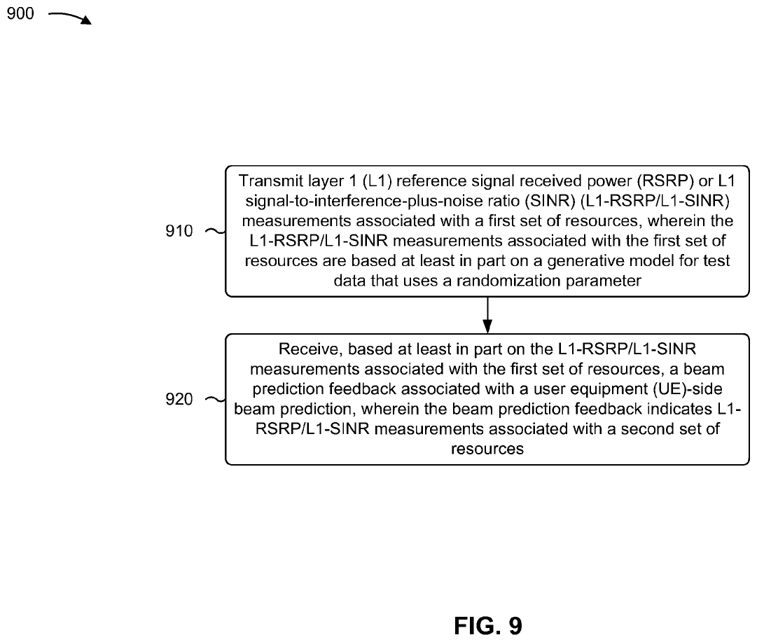

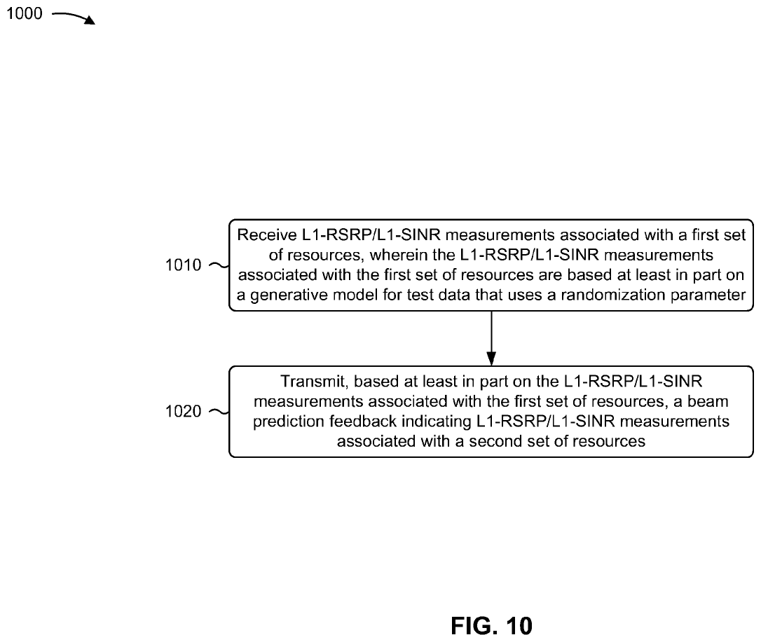

The controller/processor 240 of the network node 110, the controller/processor 280 of the UE 120, and/or any other component(s) of FIG. 2 may perform one or more techniques associated with generative models for generating performance test data for UE-side beam prediction, as described in more detail elsewhere herein. In some aspects, the TE described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a TE (e.g., the TE 122) includes means for transmitting L1-RSRP/L1-SINR measurements associated with a first set of resources, wherein the L1-RSRP/L1-SINR measurements associated with the first set of resources are based at least in part on a generative model for test data that uses a randomization parameter; and/or means for receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources. In some aspects, the means for the TE to perform operations described herein may include, for example, one or more of communication manager 150, antenna 252, modem 254, MIMO detector 256, receive processor 258, transmit processor 264, TX MIMO processor 266, controller/processor 280, or memory 282.

In some aspects, a UE (e.g., the UE 120) includes means for receiving L1-RSRP/L1-SINR measurements associated with a first set of resources, wherein the L1-RSRP/L1-SINR measurements associated with the first set of resources are based at least in part on a generative model for test data that uses a randomization parameter; and/or means for transmitting, based at least in part on the L1-RSRP/L1-SINR measurements associated with the first set of resources, a beam prediction feedback indicating L1-RSRP/L1-SINR measurements associated with a second set of resources. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

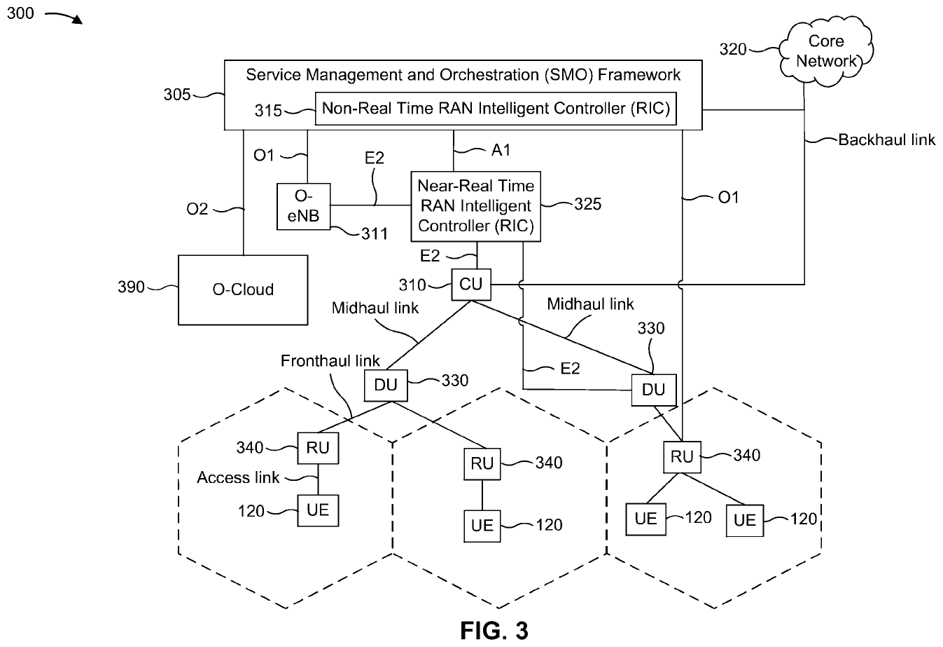

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle OTA communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

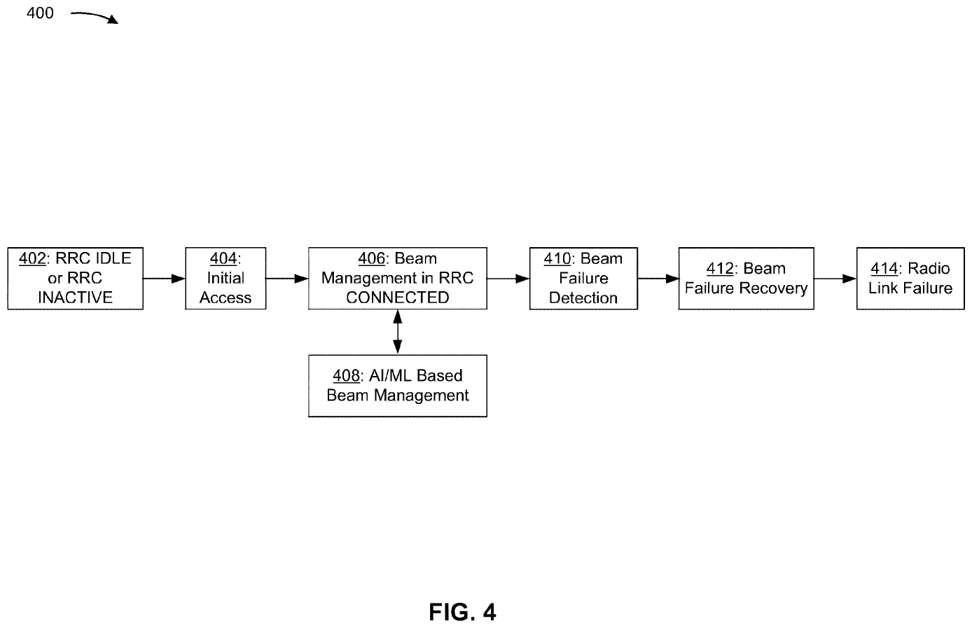

FIG. 4 is a diagram illustrating an example 400 of beam management, in accordance with the present disclosure.

As shown by reference number 402, a UE may initially be in an RRC idle state or an RRC inactive state. As shown by reference number 404, the UE may perform an initial access. As shown by reference number 406, the UE may perform a beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure.

The P2 beam management procedure may be a beam refinement procedure, a network node beam refinement procedure, a TRP beam refinement procedure, and/or a Tx beam refinement procedure. The P3 beam management procedure may be a beam refinement procedure, a UE beam refinement procedure, and/or a receive (Rx) beam refinement procedure. As shown by reference number 408, the UE may also perform beam management using an AI/ML-based approach. The beam management using the AI/ML-based approach may use an AI/ML model in a spatial domain (SD), a time domain (TD), and/or a frequency domain (FD), which may reduce signaling overhead and latency and improve a beam selection accuracy. The AI/ML model may be associated with a lifecycle management, which may involve a model training, model deployment, model inference, model monitoring, and/or model updating. As shown by reference number 410, the UE may perform a beam failure detection (BFD), which may be based at least in part on measurements obtained during the beam management after entering the RRC connected mode. As shown by reference number 412, the UE may perform a beam failure recovery (BFR) based at least in part on the BFD. As shown by reference number 414, when the BFR is not successful, the UE may declare a radio link failure (RLF).

As indicated above, FIG. 4 is provided as an example. Other examples may differ from what is described with regard to FIG. 4.

For an AI/ML-based beam management, a first beam management case and a second beam management case may be supported for characterization and baseline performance evaluations. The first beam management case may involve an SD downlink beam prediction for a first set of beams (Set A) based at least in part on measurement results of a second set of beams (Set B). The second beam management case may involve a temporal downlink beam prediction for the first set of beams based at least in part on historical measurement results of the second set of beams. For the first beam management case and the second beam management case, beams in the first set of beams and beams in the second set of beams may be in the same frequency range.

In the first beam management case, in a first alternative, the second set of beams may be a subset of the first set of beams. In the first alternative, the first set of beams and the second set of beams may each be associated with a defined quantity of beams. The second set of beams may be determined from beams in the first set of beams based at least in part on a fixed pattern or a random pattern. In a second alternative, the first set of beams may be different from the second set of beams (e.g., the first set of beams may include narrow beams and the second set of beams may include wide beams). In the second alternative, the first set of beams and the second set of beams may each be associated with a defined quantity of beams. A quasi co-location (QCL) relation may be defined between beams in the first set of beams and beams in the second set of beams. Further, the first set of beams may be for downlink beam prediction, and the second set of beams may be for downlink beam measurement.

For the first beam management case and with a UE-side AI/ML model, layer 1 (L1) signaling may be used to report information associated with an AI/ML model inference to a network node. The information may indicate one or more beams (e.g., reported beams) that are based at least in part on an output of the AI/ML model inference. The information may indicate predicted L1-RSRP measurements corresponding to the one or more beams.

For the second beam management case and with the UE-side AI/ML model, L1 signaling may be used to report information associated with the AI/ML model inference to the network node. The information may indicate one or more beams of N upcoming time instances, where the one or more beams may be based at least in part on the output of the AI/ML model inference. A value for N may be defined. The information may indicate predicted L1-RSRP measurements corresponding to the one or more beams. The information may indicate a timestamp corresponding to the one or more beams, where the timestamp may be indicated explicitly or implicitly.

For the first and second beam management cases with the UE-side AI/ML model, a model monitoring may be employed. For a UE-side model monitoring, the UE may monitor performance metrics. The UE may perform decisions of model selection, activation, deactivation, switching, or fallback operation based at least in part on the performance metrics. For a network-side model monitoring, the network node may monitor performance metrics. The network node may perform decisions of model selection, activation, deactivation, switching, or fallback operation based at least in part on the performance metrics. In a hybrid model monitoring, the UE may monitor performance metrics, and the network node may perform decisions of model selection, activation, deactivation, switching, or fallback operation based at least in part on the performance metrics.

For the first and second beam management cases with a network-side AI/ML model, the network-side model monitoring may be employed. The network node may monitor the performance metrics, and the network node may perform decisions of model selection, activation, deactivation, switching, or fallback operation based at least in part on the performance metrics. For the first and second beam management cases with the network-side AI/ML model, a beam measurement and report for model monitoring may be employed. For the first and second beam management cases with the network-side AI/ML model, the UE may report measurement results of more than four beams in one reporting instance based at least in part on an L1 beam reporting for the AI/ML model inference.

Performance testing of a UE may be used to evaluate an accuracy of a UE-side beam prediction. Performance testing may indicate whether the UE-side beam prediction is relatively accurate or relatively inaccurate. UE-side beam prediction may include AI/ML based L1-RSRP/L1-SINR prediction, and/or AI/ML based top-K-resource prediction. Such UE-side beam prediction may be verified in terms of performance testing across different operating scenarios and/or environments. The different operating scenarios and/or environments may include indoor/outdoor environments, large/small delay spread scenarios, and/or high/low Doppler shift scenarios.

Performance testing may typically be done using OTA testing. OTA testing may be used for L1-RSRP/L1-SINR measurement testing, for which OTA testing may be considered based at least in part on relatively simple environments in a chamber.

However, performing testing for UE-side beam prediction using OTA testing (or an OTA setup) may not be suitable. When evaluating the accuracy of the UE-side beam prediction using OTA testing, generating various scenarios and/or environments associated with indoor/outdoor, large/small delay spread, and/or high/low Doppler shift may be relatively complex. In the OTA setup, such various scenarios and/or environments may be unable to be simulated, which may result in the UE-side beam prediction being inadequately evaluated for the UE. Performance testing using OTA may not verify the accuracy of the UE-side beam prediction when faced with the various scenarios and/or environments. As a result, UE-side beam prediction may not be adequately tested, and a relatively inaccurate UE-side beam prediction may be used, thereby degrading an overall performance of the UE.

In various aspects of techniques and apparatuses described herein, a TE may generate, using a generative model for test data, L1-RSRP/L1-SINR measurements associated with a first set of resources based at least in part on a randomization parameter. The generative model for test data may use the randomization parameter when deriving the L1-RSRP/L1-SINR measurements associated with the first set of resources. The TE may transmit, to a UE, the L1-RSRP/L1-SINR measurements associated with the first set of resources. The TE may generate, using the generative model for test data, reproduced L1-RSRP/L1-SINR measurements associated with a second set of resources. The UE may determine, based at least in part on the L1-RSRP/L1-SINR measurements associated with the first set of resources, L1-RSRP/L1-SINR measurements associated with the second set of resources based at least in part on a UE-side beam prediction. The TE may receive, from the UE, beam prediction feedback that indicates the L1-RSRP/L1-SINR measurements associated with the second set of resources. The UE may perform a comparison of the reproduced L1-RSRP/L1-SINR measurements associated with the second set of resources and the L1-RSRP/L1-SINR measurements associated with the second set of resources, as received from the UE. The UE may determine, based at least in part on the comparison, an accuracy of the UE-side beam prediction.

In some aspects, performance testing for UE-side beam prediction (e.g., AI/ML based beam prediction) may be based at least in part on a conducted performance test and a generative model for test data (or multiple generative models for test data). The UE may be connected via a cable to the TE. The UE may receive the test data from the TA via the cable, as opposed to measuring signals in an OTA manner. The test data may be in the form of measurement results with respect to wide beams (e.g., Set B beams). The UE may transmit, to the TE and via the cable or an air interface using OTA, beam prediction feedback. The prediction results may be based at least in part on the test data. The TE may receive the prediction results from the UE.

The TE may compare the prediction results to true values (e.g., values that should be derived given the test data), and based at least in part on the comparison, the TE may determine a prediction accuracy performance of the UE-side beam prediction.

In some aspects, the generative model for test data may be defined in a standard, which may allow the TE to prepare the test data (e.g., test datasets) following unified rules. The test data, which may be associated with Set B measurement results, may be generated in a predefined manner in accordance with the standard. In some aspects, an interface between the UE and the TE for transferring the test data may be defined. Rules for transferring the test data generated by the generative models, from the TE to the UE, together with connections with respect to defined beam prediction feedback mechanisms, may be defined. For example, the associations may define which L1-RSRP/L1-SINR measurements are associated with which defined beam prediction feedback occasion.

In some aspects, by implementing the performance testing for UE-side beam prediction using the generative model for test data and the conducted performance test, an accuracy of the UE-side beam prediction may be evaluated, without relying on OTA testing. The generative model for test data may be able to simulate different operating scenarios and/or environments associated with indoor/outdoor, large/small delay spread, and/or high/low Doppler shift. The performance testing for UE-side beam prediction using the generative model for test data and the conducted performance test may result in an adequate testing of the UE-side beam prediction, which may prevent relatively inaccurate UE-side beam prediction from being used, thereby improving an overall performance of the UE.

In some aspects, when the test data is derived using the generative model for test data, the test data may be randomly generated for the different operating scenarios and/or environments (e.g., using the randomization parameters). Due to the large number of possible values for the test data, the UE may be less likely to be aware of the contents of the test data, and thus, the UE may be less likely to “cheat” on the performance testing. For example, the UE-side beam prediction may be of relatively poor accuracy, but when the UE-side beam prediction is aware of the test data, the UE may produce favorable beam prediction feedback because the test data is already known to the UE. The performance testing may mistakenly indicate that the UE-side beam prediction is relatively accurate, even though that is not true. On the other hand, when the generative models are used to generate the test data using the randomization parameters, the UE may be less likely to be aware of the contents of the test data, so beam prediction feedback based at least in part on the test data may be a more reliable reflection of the accuracy of the UE-side beam prediction.

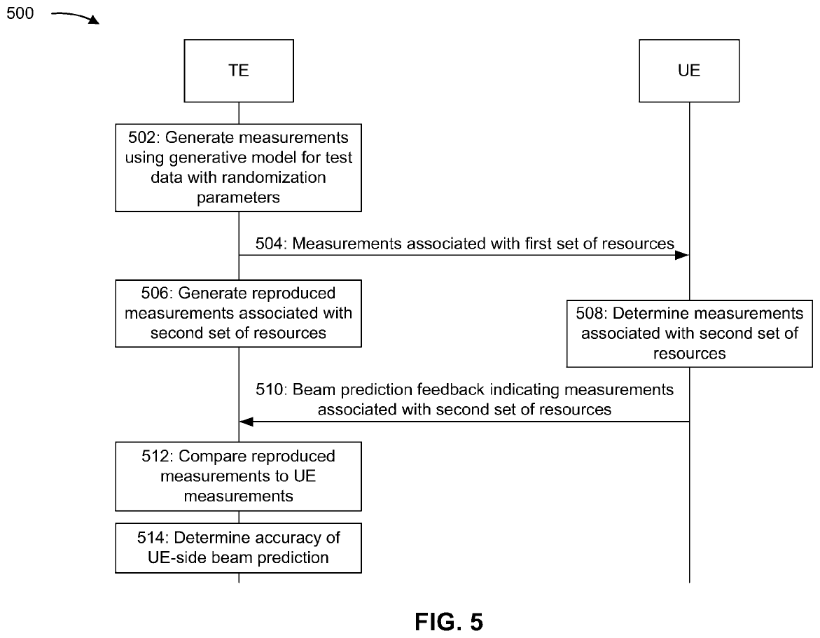

FIG. 5 is a diagram illustrating an example 500 associated with generative models for generating performance test data for UE-side beam prediction, in accordance with the present disclosure. As shown in FIG. 5, example 500 includes communication between a TE (e.g., TE 122) and a UE (e.g., UE 120). In some aspects, the TE and the UE may be included in a wireless network, such as wireless network 100.

As shown by reference number 502, the TE may generate, using a generative model for test data, L1-RSRP/L1-SINR measurements associated with a first set of resources based at least in part on a randomization parameter. The generative model for test data, or parameters associated with the generative model for test data, may be at least partially defined in a standard (e.g., a 3GPP specification). In some aspects, the generative model for test data may be defined based at least in part on analytical or statistical expressions, for generating the L1-RSRP/L1-SINR measurements associated with the first set of resources, and with the randomization parameter. The randomization parameter may be able to be varied by the TE. The randomization parameter may be associated with a network node antenna configuration, a delay spread, an indoor environment, an outdoor environment, an urban environment, a rural environment, a cell type, a Doppler shift, and/or a UE speed. In some aspects, the generative model for test data may be defined based at least in part on an AI/ML model. Input for the AI/ML model may include the randomization parameter. The AI/ML model input may be able to be varied by the TE. In some aspects, the L1-RSRP/L1-SINR measurements associated with the first set of resources may be associated with one or more historical TD occasions. The L1-RSRP/L1-SINR measurements associated with the first set of resources may be based at least in part on a changing of the randomization parameter across the one or more historical TD occasions.

In some aspects, the generative model for test data may be specified in the standard, and/or parameters fully or partially specifying the generative model for test data may be specified in the standard. In some aspects, the generative model for test data may be defined based at least in part on explicit, analytical, and/or statistical expressions to reproduce the L1-RSRP/L1-SINR measurements, with certain randomization parameters which may be varied by the TE. A variation of the certain randomization parameters may be at least partly transparent to the UE. A network node and UE antenna configuration, a UE orientation, a UE moving direction/speed, and/or a channel propagation behavior between the UE and a network node may be assumed based at least in part on the explicit, analytical, and/or statistical expressions. The L1-RSRP/L1-SINR measurements may be reproduced based at least in part on such assumptions. Parameters associated with the UE may be compliant with a configuration associated with the UE. The randomization parameters may include the network node antenna configuration, the delay spread, an indoor/outdoor environment, an urban/rural environment, a macro/micro cell, a Doppler shift, and/or a speed associated with the UE and/or the network node.

In some aspects, a certain L1-RSRP/L1-SINR measurement received by the UE may be associated with the randomization parameter, and such association may be transparent to the UE. For example, a first L1-RSRP/L1-SINR measurement received by the UE may be associated with a 20 ns delay spread and a second L1-RSRP/L1-SINR measurement received by the UE may be associated with a 300 ns delay spread, but the UE may not be aware that the first and second L1-RSRP/L1-SINR measurements are associated with the 20 ns and 300 ns delay spreads, respectively. In some aspects, certain randomization parameters may be indicated by the TE to the UE, along with the L1-RSRP/L1-SINR measurements. For example, the TE may indicate, to the UE, whether a certain L1-RSRP/L1-SINR measurement is associated with an indoor/outdoor scenario, a certain UE moving speed, and/or a certain network node antenna down-tilting angle.

In some aspects, the generative model for test data may be defined based at least in part on the AI/ML model. AI/ML model inputs may include at least the randomization parameters. The TE may vary such AI/ML model inputs, but a variation of the AI/ML model inputs may be at least partly transparent to the UE. The TE may or may not inform the UE regarding AI/ML model input variations regarding a specific L1-RSRP/L1-SINR measurement associated with the test data. A structure, weights, and/or a bias associated with the AI/ML model may be defined in the standard. The AI/ML model may be a generative adversarial network (GAN) model and/or another type of advanced generative AI/ML model.

In some aspects, the L1-RSRP/L1-SINR measurements associated with the first set of resources may include a first portion of L1-RSRP/L1-SINR measurements and a second portion of L1-RSRP/L1-SINR measurements. In some aspects, the first portion of L1-RSRP/L1-SINR measurements and the second portion of L1-RSRP/L1-SINR measurements may be both associated with the generative model for test data that is defined based at least in part on analytical or statistical expressions. In some aspects, the first portion of L1-RSRP/L1-SINR measurements and the second portion of L1-RSRP/L1-SINR measurements may both be associated with the generative model for test data that is defined based at least in part on an AI/ML model. In some aspects, the first portion of L1-RSRP/L1-SINR measurements may be associated with the generative model for test data that is defined based at least in part on analytical or statistical expressions, and the second portion of L1-RSRP/L1-SINR measurements may be associated with the generative model for test data that is defined based at least in part on an AI/ML model.

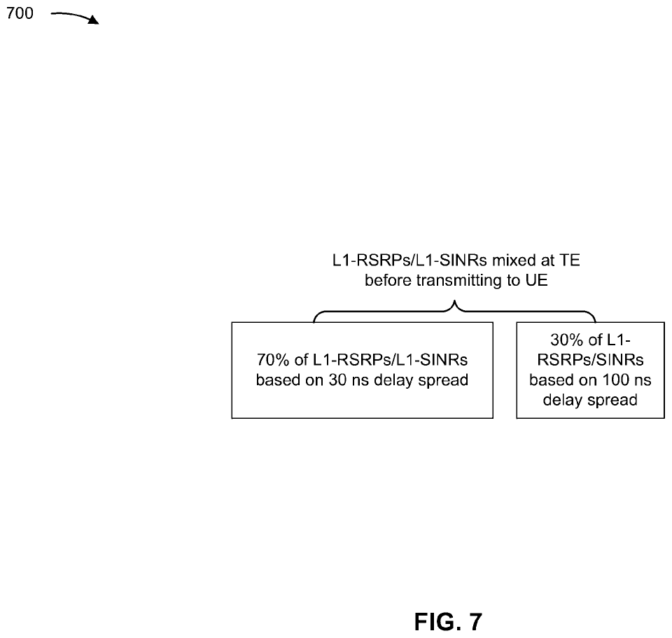

In some aspects, for the UE-side beam prediction performance testing, the UE may receive L1-RSRP/L1-SINR measurements that are generated using different methodologies. For example, some L1-RSRP/L1-SINR measurements may be generated using the generative model for test data that are defined based at least in part on the explicit, analytical, and/or statistical expressions (e.g., a first methodology), whereas other L1-RSRP/L1-SINR measurements may be generated using the generative model for test data that are defined based at least in part on the AI/ML model (e.g., a second methodology). A ratio of the mixture of the different methodologies may be defined in the standard (e.g., as shown in FIG. 7).

In some aspects, when L1-RSRP/L1-SINR measurements are generated using the generative model for test data that is defined based at least in part on the explicit, analytical, and/or statistical expressions, the UE may receive X % L1-RSRPs/L1-SINR measurements based at least in part on a first delay spread, and Y % L1-RSRPs/L1-SINR measurements based at least in part on a second delay spread. The values of X and Y together with values of the first and second delay spreads may be defined in the standard, or may be provided by the TE to the UE. However, the UE may not be notified of a specific L1-RSRP/L1-SINR measurement being associated with a specific delay spread value.

In some aspects, when L1-RSRP/L1-SINR measurements are generated using the generative model for test data that is defined based at least in part on the AI/ML model, the UE may receive X % L1-RSRP/L1-SINR measurements based at least in part on an AI/ML model output associated with a model input including a first delay spread, and Y % L1-RSRP/L1-SINR measurements based at least in part on an AI/ML model output associated with a model input including a second delay spread. The values of X and Y together with values of the first and second delay spreads may be defined in the standard, or may be provided by the TE to the UE. However, the UE may not be notified of a specific L1-RSRP/L1-SINR measurement being associated with a specific delay spread value.

In some aspects, L1-RSRP/L1-SINR measurements may be generated using the generative model for test data that is defined based at least in part on the explicit, analytical, and/or statistical expressions, and the L1-RSRP/L1-SINR measurements may be generated based at least in part on the AI/ML model (e.g., both the first methodology and the second methodology are jointly considered). The UE may receive X % L1-RSRP/L1-SINR measurements based at least in part on the first methodology, and Y % L1-RSRP/L1-SINR measurements based at least in part on the second methodology.

The values of X and Y together with at least a portion of parameters used by the two methodologies may be defined in the standard, or may be informed by the TE to the UE. However, the UE may not be aware of a specific L1-RSRP/L1-SINR measurement associated with a specific methodology.

In some aspects, when generating the L1-RSRP/L1-SINR measurements using the generative model for test data that is defined based at least in part on the explicit, analytical, and/or statistical expressions, or based at least in part on the AI/ML model, such approaches for generating the L1-RSRP/L1-SINR measurements may be applied to both the first set of resources and the second set of resources, which may be based at least in part on the same set or different sets of methodologies or randomization parameters being used for the two sets of resources. Further, the TE may or may not indicate, to the UE, parameters with respect to the second set of resources.

As shown by reference number 504, the TE may transmit, to the UE, the L1-RSRP/L1-SINR measurements associated with the first set of resources. The L1-RSRP/L1-SINR measurements associated with the first set of resources may be derived based at least in part on the generative model for test data that uses the randomization parameter. The L1-RSRP/L1-SINR measurements associated with the first set of resources may be transmitted via a cable between the TE and the UE. In some aspects, the TE may transmit, to the UE, an indication of associations between the first set of resources and a second set of resources. The indication may indicate a QCL, a relative beam pointing direction, a relative beamwidth, an absolute beam point direction, and/or an absolute beamwidth, with respect to the associations between the first set of resources and a second set of resources. In some aspects, the TE may transmit, to the UE, an indication of the randomization parameter used by the generative model for test data to generate the L1-RSRP/L1-SINR measurements associated with the first set of resources.

In some aspects, generative models for test data may be defined for UE-side beam prediction performance testing. To test a beam prediction performance, the UE may receive, from the TE, the test data. The test data may include the L1-RSRP/L1-SINR measurements regarding the first set of resources. The first set of resources may be SSBs and/or CSI-RSs. The UE may receive, from the TE, the indication of associations between the first set of resources and the second set of resources, which may be based at least in part on QCLs, relative beam pointing directions or beamwidths, absolute beam pointing directions or beamwidths, and/or antenna panel identifiers (IDs). The UE may receive, from the TE and via the cable that connects the UE and the TE, the L1-RSRP/L1-SINR measurements, and/or the indication of associations between the first set of resources and a second set of resources. The L1-RSRP/L1-SINR measurements regarding the first set of resources may be associated with one or more historical TD occasions.

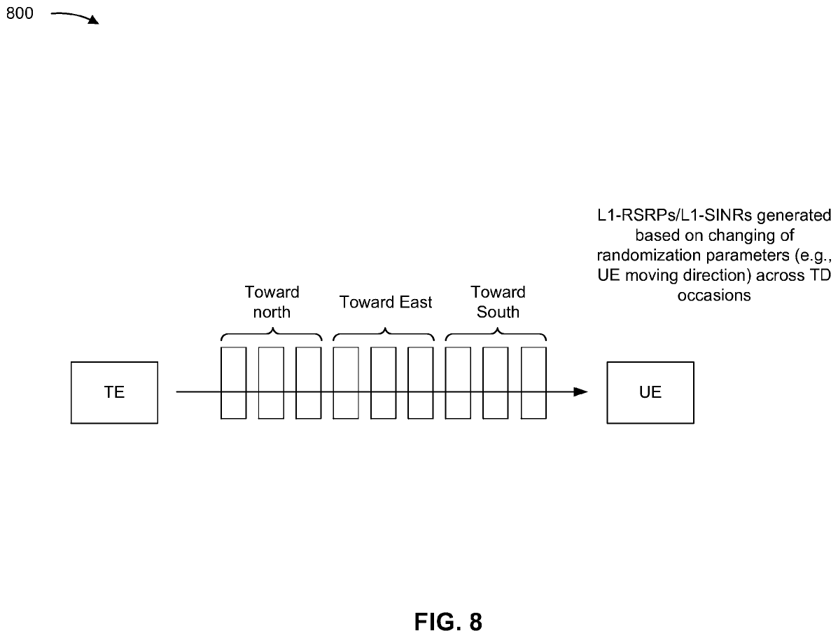

In some aspects, the L1-RSRP/L1-SINR measurements associated with the first set of resources, as received by the UE from the TE, may be associated with multiple historical TD occasions. For example, different randomization parameters associated with a UE moving speed/direction and/or a UE orientation may vary across different historical TD occasions. L1-RSRP/L1-SINR measurements may be generated based at least in part on changing the randomization parameters (e.g., UE moving direction) across TD occasions (e.g., as shown in FIG. 8). While rules for varying such randomization parameters may be defined in the standard, the TE may or may not indicate, to the UE, exact values associated with the randomization parameters with respect to the different historical TD occasions.

As shown by reference number 506, the TE may generate, using the generative model for test data, reproduced L1-RSRP/L1-SINR measurements associated with the second set of resources. The L1-RSRP/L1-SINR measurements associated with the first set of resources and the reproduced L1-RSRP/L1-SINR measurements associated with the second set of resources may be associated with the same randomization parameter. In some aspects, the reproduced L1-RSRP/L1-SINR measurements associated with the second set of resources may be associated with multiple future TD occasions, and the multiple future TD occasions may be associated with the same prediction instance. For example, a first randomization parameter associated with a first TD occasion, of the multiple future TD occasions, may correspond to a second randomization parameter associated with a second TD occasion, of the multiple future TD occasions.

In some aspects, when considering L1-RSRP/L1-SINR measurements from two different future TD occasions, of the second set of resources, associated with the same prediction instance, the same randomization parameters may be associated with the two different future TD occasions, or different randomization parameters may be associated with the two different future TD occasions. As an example, different randomization parameters associated with a UE moving speed/direction and/or a UE orientation may vary across different future TD occasions, regardless of whether the generative model for test data is defined based at least in part on the explicit, analytical, and/or statistical expressions, or based at least in part on the AI/ML model.

As shown by reference number 508, the UE may determine, based at least in part on the L1-RSRP/L1-SINR measurements associated with the first set of resources, L1-RSRP/L1-SINR measurements associated with a second set of resources. The UE may determine the L1-RSRP/L1-SINR measurements associated with the second set of resources based at least in part on a UE-side beam prediction. The UE may perform the UE-side beam prediction using an AI/ML model for beam prediction that runs on the UE. In some aspects, the first set of resources and the second set of resources may be non-overlapping resources based at least in part on the L1-RSRP/L1-SINR measurements associated with the first set of resources and the L1-RSRP/L1-SINR measurements associated with the second set of resources being associated with a same TD occasion. In some aspects, the first set of resources and the second set of resources may be overlapping resources based at least in part on the L1-RSRP/L1-SINR measurements associated with the second set of resources being associated with a future TD occasion.

As shown by reference number 510, the UE may transmit, to the TE, beam prediction feedback associated with the UE-side beam prediction. The beam prediction feedback may indicate the L1-RSRP/L1-SINR measurements associated with the second set of resources. The L1-RSRP/L1-SINR measurements associated with the second set of resources may be transmitted via the cable or via an air interface between the TE and the UE.

In some aspects, the UE may transmit, to the TE, the beam prediction feedback. The beam prediction feedback may be associated with beam prediction results. The beam prediction feedback may indicate predicted channel characteristics associated with the second set of resources. The beam prediction feedback may be based at least in part on the first set of resources. The predicted channel characteristics may be associated with SSBs, CSI-RSs, and/or virtual resources. The UE may transmit the beam prediction feedback to the TE via the cable or via an air interface. The air interface may be a specified air interface to transmit the beam prediction feedback. The predicted channel characteristics may include the L1-RSRP/L1-SINR measurements, or top-K-resources in terms of L1-RSRP/L1-SINR measurements, associated with the second set of resources. The first set of resources and the second set of resources may be non-overlapping when the predicted channel characteristics are regarding the same TD occasion associated with L1-RSRP/L1-SINR measurements received by the UE or regarding future TD occasions. The first set of resources and the second set of resources may be overlapping when the predicted channel characteristics are regarding future TD occasions.

In some aspects, for a temporal UE-side beam prediction performance testing, the L1-RSRP/L1-SINR measurements regarding the second set of resources associated with multiple future TD occasions may be reproduced by the generative model for test data. The TE may reproduce the L1-RSRP/L1-SINR measurements associated with the second set of resources using the generative model for test data. Additionally, the L1-RSRP/L1-SINR measurements associated with the second set of resources may be predicted by the UE using the UE-side beam prediction. The UE may transmit, to the TE, the beam prediction feedback indicating the predicted L1-RSRP/L1-SINR measurements.

As shown by reference number 512, the TE may perform a comparison of the reproduced L1-RSRP/L1-SINR measurements associated with the second set of resources and the L1-RSRP/L1-SINR measurements associated with the second set of resources, as received from the UE. In other words, the TE may compare the reproduced L1-RSRP/L1-SINR measurements associated with the second set of resources, which the UE may assume as being true L1-RSRP/L1-SINR measurements, with the L1-RSRP/L1-SINR measurements received from the UE.

As shown by reference number 514, the TE may determine, based at least in part on the comparison, an accuracy of the UE-side beam prediction. When the L1-RSRP/L1-SINR measurements received from the UE are relatively close to the reproduced L1-RSRP/L1-SINR measurements, the TE may determine that the UE-side beam prediction is relatively accurate. When the L1-RSRP/L1-SINR measurements received from the UE differ from the reproduced L1-RSRP/L1-SINR measurements by at least a certain threshold value, the TE may determine that the UE-side beam prediction is relatively inaccurate.

In some aspects, the L1-RSRP/L1-SINR measurements regarding the first set of resources may be generated, by the TE, based at least in part on the generative model for test data (or multiple models for test data). In other words, the test data may be generated by the TE using the one or more generative models. The generative model for test data itself, or parameters that fully or partially specify the generative model for test data, may be defined in a standard (e.g., a 3GPP specification). Further, the TE, via the generative model for test data, may also reproduce the L1-RSRP/L1-SINR measurements associated with the second set of resources. The TE may compare the reproduced L1-RSRP/L1-SINR measurements associated with the second set of resources to the beam prediction feedback indicating predicted channel characteristics associated with the second set of resources, and based at least in part on the comparison, the TE may be able to evaluate the beam prediction feedback received from the UE.

As indicated above, FIG. 5 is provided as an example. Other examples may differ from what is described with regard to FIG. 5.

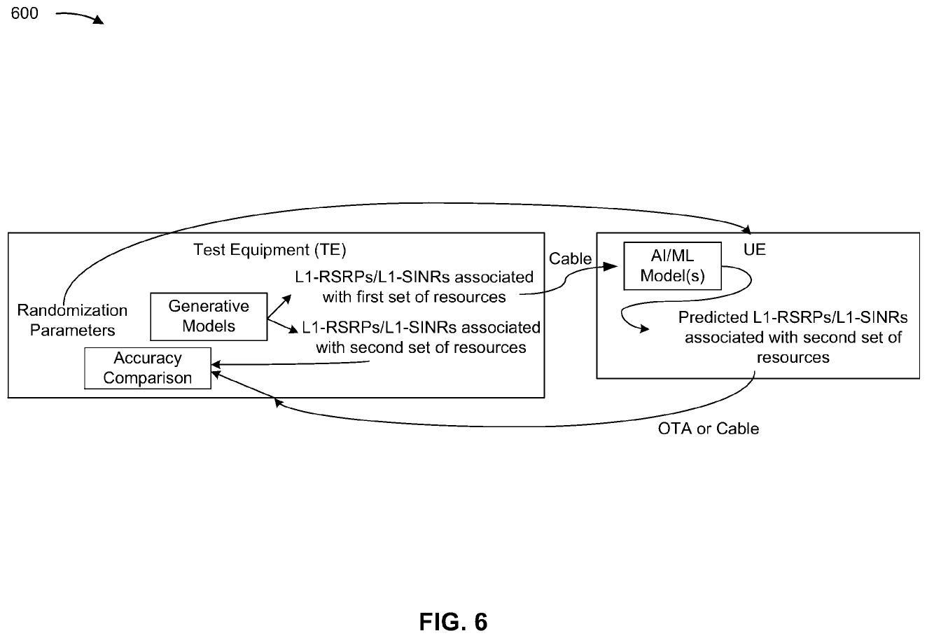

FIG. 6 is a diagram illustrating an example 600 associated with generative models for generating performance test data for UE-side beam prediction, in accordance with the present disclosure.

As shown in FIG. 6, a UE may be connected to a TE. The UE may be connected to the TE via a cable and/or an air interface. The TE may store a generative model for test data (or multiple generative models for test data). The generative model for test data may be used to generate L1-RSRP/L1-SINR measurements associated with a first set of resources (e.g., Set B beams). The L1-RSRP/L1-SINR measurements associated with the first set of resources may be generated using randomization parameters. The TE may or may not indicate the randomization parameters to the UE. The generative model for test data and/or parameters at least partially specifying the generative model for test data may be defined in a standard. The generative model for test data may also be used to generate L1-RSRP/L1-SINR measurements associated with a second set of resources (e.g., Set A beams) (e.g., reproduced L1-RSRP/L1-SINR measurements associated with the second set of resources).

In some aspects, the TE may indicate, to the UE and via the cable, the L1-RSRP/L1-SINR measurements associated with the first set of resources. The UE, using a UE-side beam prediction based at least in part on AI/ML model(s) that run on the UE, may determine beam prediction results based at least in part on the L1-RSRP/L1-SINR measurements associated with the first set of resources. The beam prediction results may include predicted L1-RSRP/L1-SINR measurements or top-K-resources in terms of L1-RSRP/L1-SINR measurements, with respect to the second set of resources. The UE may indicate, to the TE and via the cable or the air interface, the beam prediction results. The TE may compare the beam prediction results (e.g., the L1-RSRP/L1-SINR measurements associated with the second set of resources), as received from the UE, to the reproduced L1-RSRP/L1-SINR measurements associated with the second set of resources. The TE may determine an accuracy of the UE-side beam prediction based at least in part on the comparison.

As indicated above, FIG. 6 is provided as an example. Other examples may differ from what is described with regard to FIG. 6.

FIG. 7 is a diagram illustrating an example 700 associated with generative models for generating performance test data for UE-side beam prediction, in accordance with the present disclosure.

As shown in FIG. 7, a TE may mix L1-RSRP/L1-SINR measurements generated using different methodologies. The TE may mix the L1-RSRP/L1-SINR measurements before transmitting the L1-RSRP/L1-SINR measurements to a UE. The TE may mix the L1-RSRP/L1-SINR measurements in accordance with a certain ratio, which may be defined in a specification. For example, approximately 70% of the L1-RSRP/L1-SINR measurements may be based at least in part on a 30 ns delay spread, and approximately 30% of the L1-RSRP/L1-SINR measurements may be based at least in part on a 100 ns delay spread.

As indicated above, FIG. 7 is provided as an example. Other examples may differ from what is described with regard to FIG. 7.

FIG. 8 is a diagram illustrating an example 800 associated with generative models for generating performance test data for UE-side beam prediction, in accordance with the present disclosure.

As shown in FIG. 8, L1-RSRP/L1-SINR measurements associated with a first set of resources may be generated based at least in part by changing randomization parameters across TD occasions. For example, the randomization parameters may be changed based at least in part on a UE moving direction. A first set of L1-RSRP/L1-SINR measurements associated with a first set of TD occasions may be for when a UE is moving north, a second set of L1-RSRP/L1-SINR measurements associated with a second set of TD occasions may be for when the UE is moving east, and a third set of L1-RSRP/L1-SINR measurements associated with a third set of TD occasions may be for when the UE is moving south.

As indicated above, FIG. 8 is provided as an example. Other examples may differ from what is described with regard to FIG. 8.

FIG. 9 is a diagram illustrating an example process 900 performed, for example, at a TE or an apparatus of a TE, in accordance with the present disclosure.

Example process 900 is an example where the apparatus or the TE (e.g., TE 122) performs operations associated with generative models for generating performance test data for UE-side beam prediction.

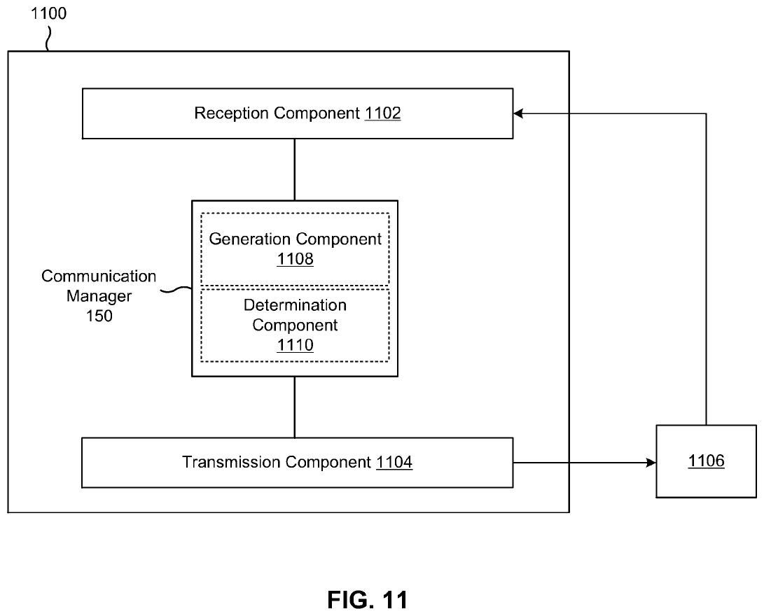

As shown in FIG. 9, in some aspects, process 900 may include transmitting L1-RSRP/L1-SINR measurements associated with a first set of resources, wherein the L1-RSRP/L1-SINR measurements associated with the first set of resources are based at least in part on a generative model for test data that uses a randomization parameter (block 910). For example, the TE (e.g., using communication manager 150 and/or transmission component 1104, depicted in FIG. 11) may transmit L1-RSRP/L1-SINR measurements associated with a first set of resources, wherein the L1-RSRP/L1-SINR measurements associated with the first set of resources are based at least in part on a generative model for test data that uses a randomization parameter, as described above.

As further shown in FIG. 9, in some aspects, process 900 may include receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources (block 920). For example, the TE (e.g., using communication manager 150 and/or reception component 1102, depicted in FIG. 11) may receive, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources, as described above.

Process 900 may include additional aspects, such as any single aspect or any combination of aspects described below and/or in connection with one or more other processes described elsewhere herein.

In a first aspect, process 900 includes generating, based at least in part on the generative model for test data, the L1-RSRP/L1-SINR measurements associated with the first set of resources based at least in part on the randomization parameter.

In a second aspect, alone or in combination with the first aspect, the generative model for test data or parameters associated with the generative model for test data are at least partially defined in a 3GPP specification.

In a third aspect, alone or in combination with one or more of the first and second aspects, process 900 includes generating, based at least in part on the generative model for test data, reproduced L1-RSRP/L1-SINR measurements associated with the second set of resources, and determining, based at least in part on a comparison of the reproduced L1-RSRP/L1-SINR measurements associated with the second set of resources and the L1-RSRP/L1-SINR measurements associated with the second set of resources, an accuracy of the UE-side beam prediction.

In a fourth aspect, alone or in combination with one or more of the first through third aspects, process 900 includes transmitting an indication of associations between the first set of resources and the second set of resources, wherein the indication indicates one or more of a QCL, a relative beam pointing direction, a relative beamwidth, an absolute beam point direction, or an absolute beamwidth.

In a fifth aspect, alone or in combination with one or more of the first through fourth aspects, the L1-RSRP/L1-SINR measurements associated with the first set of resources are transmitted via a cable between the TE and a UE, and the L1-RSRP/L1-SINR measurements associated with the second set of resources are received via the cable or via an air interface between the TE and the UE.

In a sixth aspect, alone or in combination with one or more of the first through fifth aspects, the first set of resources and the second set of resources are non-overlapping based at least in part on the L1-RSRP/L1-SINR measurements associated with the first set of resources and the L1-RSRP/L1-SINR measurements associated with the second set of resources being associated with a same time domain occasion.

In a seventh aspect, alone or in combination with one or more of the first through sixth aspects, the first set of resources and the second set of resources overlap based at least in part on the L1-RSRP/L1-SINR measurements associated with the second set of resources being associated with a future time domain occasion.

In an eighth aspect, alone or in combination with one or more of the first through seventh aspects, the generative model for test data is defined based at least in part on an analytical expression or a statistical expression, and with the randomization parameter that is able to be varied by the TE.

In a ninth aspect, alone or in combination with one or more of the first through eighth aspects, the randomization parameter is associated with one of a network node antenna configuration, a delay spread, an indoor environment, an outdoor environment, an urban environment, a rural environment, a cell type, a Doppler shift, or a UE speed.

In a tenth aspect, alone or in combination with one or more of the first through ninth aspects, process 900 includes transmitting an indication of the randomization parameter used by the generative model for test data to generate the L1-RSRP/L1-SINR measurements associated with the first set of resources.

In an eleventh aspect, alone or in combination with one or more of the first through tenth aspects, the generative model for test data is defined based at least in part on an AI/ML model, an AI/ML model input includes the randomization parameter, and the AI/ML model input is able to be varied by the TE.

In a twelfth aspect, alone or in combination with one or more of the first through eleventh aspects, the L1-RSRP/L1-SINR measurements associated with the first set of resources include a first portion of L1-RSRP/L1-SINR measurements and a second portion of L1-RSRP/L1-SINR measurements.

In a thirteenth aspect, alone or in combination with one or more of the first through twelfth aspects, the first portion of L1-RSRP/L1-SINR measurements and the second portion of L1-RSRP/L1-SINR measurements are associated with the generative model for test data that is defined based at least in part on an analytical expression or a statistical expression.

In a fourteenth aspect, alone or in combination with one or more of the first through thirteenth aspects, the first portion of L1-RSRP/L1-SINR measurements and the second portion of L1-RSRP/L1-SINR measurements are associated with the generative model for test data that is defined based at least in part on an AI/ML model.

In a fifteenth aspect, alone or in combination with one or more of the first through fourteenth aspects, the first portion of L1-RSRP/L1-SINR measurements are associated with the generative model for test data that is defined based at least in part on an analytical expression or a statistical expression, and the second portion of L1-RSRP/L1-SINR measurements are associated with the generative model for test data that is defined based at least in part on an AI/ML model.

In a sixteenth aspect, alone or in combination with one or more of the first through fifteenth aspects, the L1-RSRP/L1-SINR measurements associated with the first set of resources and reproduced L1-RSRP/L1-SINR measurements associated with the second set of resources are associated with the randomization parameter.

In a seventeenth aspect, alone or in combination with one or more of the first through sixteenth aspects, reproducing L1-RSRP/L1-SINR measurements associated with the second set of resources are associated with multiple future time domain occasions, and the multiple future time domain occasions are associated with a same prediction instance.

In an eighteenth aspect, alone or in combination with one or more of the first through seventeenth aspects, a first randomization parameter associated with a first time domain occasion, of the multiple future time domain occasions, corresponds to a second randomization parameter associated with a second time domain occasion, of the multiple future time domain occasions.

In a nineteenth aspect, alone or in combination with one or more of the first through eighteenth aspects, the L1-RSRP/L1-SINR measurements associated with the first set of resources are associated with one or more historical time domain occasions, and the L1-RSRP/L1-SINR measurements associated with the first set of resources are based at least in part on a change in the randomization parameter across the one or more historical time domain occasions.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure.

Example process 1000 is an example where the apparatus or the UE (e.g., UE 120) performs operations associated with generative models for generating performance test data for UE-side beam prediction.

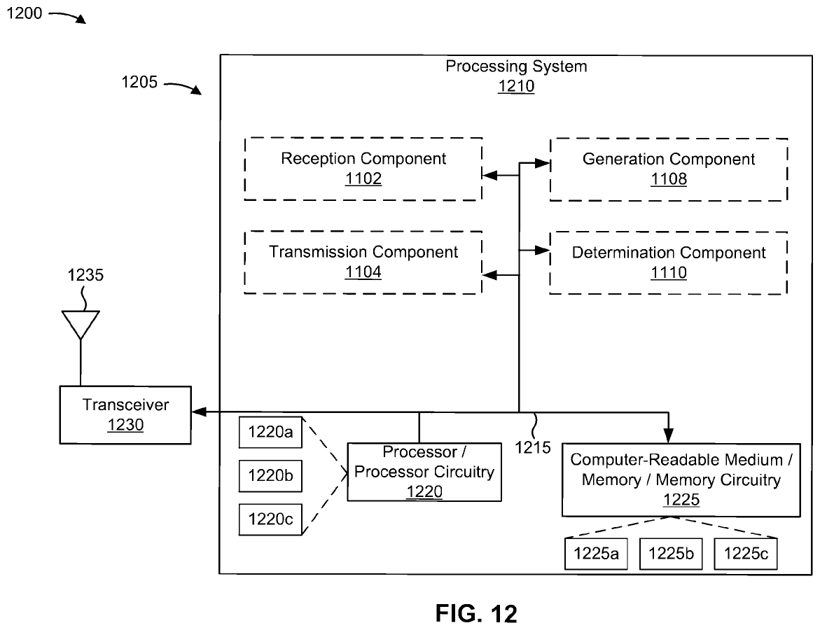

As shown in FIG. 10, in some aspects, process 1000 may include receiving L1-RSRP/L1-SINR measurements associated with a first set of resources, wherein the L1-RSRP/L1-SINR measurements associated with the first set of resources are based at least in part on a generative model for test data that uses a randomization parameter (block 1010). For example, the UE (e.g., using communication manager 140 and/or reception component 1102, depicted in FIG. 12) may receive L1-RSRP/L1-SINR measurements associated with a first set of resources, wherein the L1-RSRP/L1-SINR measurements associated with the first set of resources are based at least in part on a generative model for test data that uses a randomization parameter, as described above.

As further shown in FIG. 10, in some aspects, process 1000 may include transmitting, based at least in part on the L1-RSRP/L1-SINR measurements associated with the first set of resources, a beam prediction feedback indicating L1-RSRP/L1-SINR measurements associated with a second set of resources (block 1020). For example, the UE (e.g., using communication manager 140 and/or transmission component 1104, depicted in FIG. 12) may transmit, based at least in part on the L1-RSRP/L1-SINR measurements associated with the first set of resources, a beam prediction feedback indicating L1-RSRP/L1-SINR measurements associated with a second set of resources, as described above.

Process 1000 may include additional aspects, such as any single aspect or any combination of aspects described below and/or in connection with one or more other processes described elsewhere herein.

In a first aspect, the generative model for test data or parameters associated with the generative model for test data are at least partially defined in a 3GPP specification.

In a second aspect, alone or in combination with the first aspect, process 1000 includes receiving an indication of associations between the first set of resources and the second set of resources, wherein the indication indicates one or more of a QCL, a relative beam pointing direction, a relative beamwidth, an absolute beam point direction, or an absolute beamwidth.

In a third aspect, alone or in combination with one or more of the first and second aspects, the L1-RSRP/L1-SINR measurements associated with the first set of resources are received via a cable between the UE and a TE, and the L1-RSRP/L1-SINR measurements associated with the second set of resources are transmitted via the cable or via an air interface between the UE and the TE.

In a fourth aspect, alone or in combination with one or more of the first through third aspects, the first set of resources and the second set of resources are non-overlapping based at least in part on the L1-RSRP/L1-SINR measurements associated with the first set of resources and the L1-RSRP/L1-SINR measurements associated with the second set of resources being associated with a same time domain occasion.

In a fifth aspect, alone or in combination with one or more of the first through fourth aspects, the first set of resources and the second set of resources overlap based at least in part on the L1-RSRP/L1-SINR measurements associated with the second set of resources being associated with a future time domain occasion.

In a sixth aspect, alone or in combination with one or more of the first through fifth aspects, the generative model for test data is defined based at least in part on an analytical expression or a statistical expression, and with the randomization parameter that is variable.

In a seventh aspect, alone or in combination with one or more of the first through sixth aspects, the randomization parameter is associated with one of a network node antenna configuration, a delay spread, an indoor environment, an outdoor environment, an urban environment, a rural environment, a cell type, a Doppler shift, or a UE speed.

In an eighth aspect, alone or in combination with one or more of the first through seventh aspects, process 1000 includes receiving an indication of the randomization parameter used by the generative model for test data to generate the L1-RSRP/L1-SINR measurements associated with the first set of resources.

In a ninth aspect, alone or in combination with one or more of the first through eighth aspects, the generative model for test data is defined based at least in part on an AI/ML model, an AI/ML model input includes the randomization parameter, and the AI/ML model input is variable.

In a tenth aspect, alone or in combination with one or more of the first through ninth aspects, the L1-RSRP/L1-SINR measurements associated with the first set of resources include a first portion of L1-RSRP/L1-SINR measurements and a second portion of L1-RSRP/L1-SINR measurements.

In an eleventh aspect, alone or in combination with one or more of the first through tenth aspects, the first portion of L1-RSRP/L1-SINR measurements and the second portion of L1-RSRP/L1-SINR measurements are associated with the generative model for test data that is defined based at least in part on an analytical expression or a statistical expression.

In a twelfth aspect, alone or in combination with one or more of the first through eleventh aspects, the first portion of L1-RSRP/L1-SINR measurements and the second portion of L1-RSRP/L1-SINR measurements are associated with the generative model for test data that is defined based at least in part on an AI/ML model.

In a thirteenth aspect, alone or in combination with one or more of the first through twelfth aspects, the first portion of L1-RSRP/L1-SINR measurements are associated with the generative model for test data that is defined based at least in part on an analytical expression or a statistical expression, and the second portion of L1-RSRP/L1-SINR measurements are associated with the generative model for test data that is defined based at least in part on an AI/ML model.

In a fourteenth aspect, alone or in combination with one or more of the first through thirteenth aspects, the L1-RSRP/L1-SINR measurements associated with the first set of resources and reproduced L1-RSRP/L1-SINR measurements associated with the second set of resources are associated with the randomization parameter.

In a fifteenth aspect, alone or in combination with one or more of the first through fourteenth aspects, reproducing L1-RSRP/L1-SINR measurements associated with the second set of resources are associated with multiple future time domain occasions, and the multiple future time domain occasions are associated with a same prediction instance.

In a sixteenth aspect, alone or in combination with one or more of the first through fifteenth aspects, a first randomization parameter associated with a first time domain occasion, of the multiple future time domain occasions, corresponds to a second randomization parameter associated with a second time domain occasion, of the multiple future time domain occasions.

In a seventeenth aspect, alone or in combination with one or more of the first through sixteenth aspects, the L1-RSRP/L1-SINR measurements associated with the first set of resources are associated with one or more historical time domain occasions, and the L1-RSRP/L1-SINR measurements associated with the first set of resources are based at least in part on a change in the randomization parameter across the one or more historical time domain occasions.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a TE, or a TE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a generation component 1108, or a determination component 1110, among other examples.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the TE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the TE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the TE described in connection with FIG. 2. In some aspects, the transmission component 1104 may be co-located with the reception component 1102 in one or more transceivers.

The transmission component 1104 may transmit L1-RSRP/L1-SINR measurements associated with a first set of resources, wherein the L1-RSRP/L1-SINR measurements associated with the first set of resources are based at least in part on a generative model for test data that uses a randomization parameter. The reception component 1102 may receive, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources.

The generation component 1108 may generate, based at least in part on the generative model for test data, the L1-RSRP/L1-SINR measurements associated with the first set of resources based at least in part on the randomization parameter. The generation component 1108 may generate, based at least in part on the generative model for test data, reproduced L1-RSRP/L1-SINR measurements associated with the second set of resources. The determination component 1110 may determine, based at least in part on a comparison of the reproduced L1-RSRP/L1-SINR measurements associated with the second set of resources and the L1-RSRP/L1-SINR measurements associated with the second set of resources, an accuracy of the UE-side beam prediction.

The transmission component 1104 may transmit an indication of associations between the first set of resources and the second set of resources, wherein the indication indicates one or more of a QCL, a relative beam pointing direction, a relative beamwidth, an absolute beam point direction, or an absolute beamwidth. The transmission component 1104 may transmit an indication of the randomization parameter used by the generative model for test data to generate the L1-RSRP/L1-SINR measurements associated with the first set of resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram illustrating an example 1200 of a hardware implementation for an apparatus 1205 employing a processing system 1210, in accordance with the present disclosure. The apparatus 1205 may be a TE.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor (or processing circuitry) 1220, the illustrated components, and the computer-readable medium/memory (or memory circuitry) 1225. The processor 1220 may include multiple processors, such as processor 1220a, memory 1220b, and memory 1220c. The memory 1225 may include multiple memories, such as memory 1225a, memory 1225b, and memory 1225c. The bus 1215 may also link various other circuits, such as timing sources, peripherals, voltage regulators, and/or power management circuits.

The processing system 1210 may be coupled to a transceiver 1230. The transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes a processor 1220 coupled to a computer-readable medium/memory 1225. The processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software.

The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be a component of the TE 122 and may include the memory 282 and/or at least one of the TX MIMO processor 266, the Rx processor 258, and/or the controller/processor 280. In some aspects, the apparatus 1205 for wireless communication includes means for transmitting L1-RSRP/L1-SINR measurements associated with a first set of resources, wherein the L1-RSRP/L1-SINR measurements associated with the first set of resources are based at least in part on a generative model for test data that uses a randomization parameter; and/or means for receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the TX MIMO processor 266, the Rx processor 258, and/or the controller/processor 280. In one configuration, the aforementioned means may be the TX MIMO processor 266, the Rx processor 258, and/or the controller/processor 280 configured to perform the functions and/or operations recited herein.

FIG. 12 is provided as an example. Other examples may differ from what is described in connection with FIG. 12.

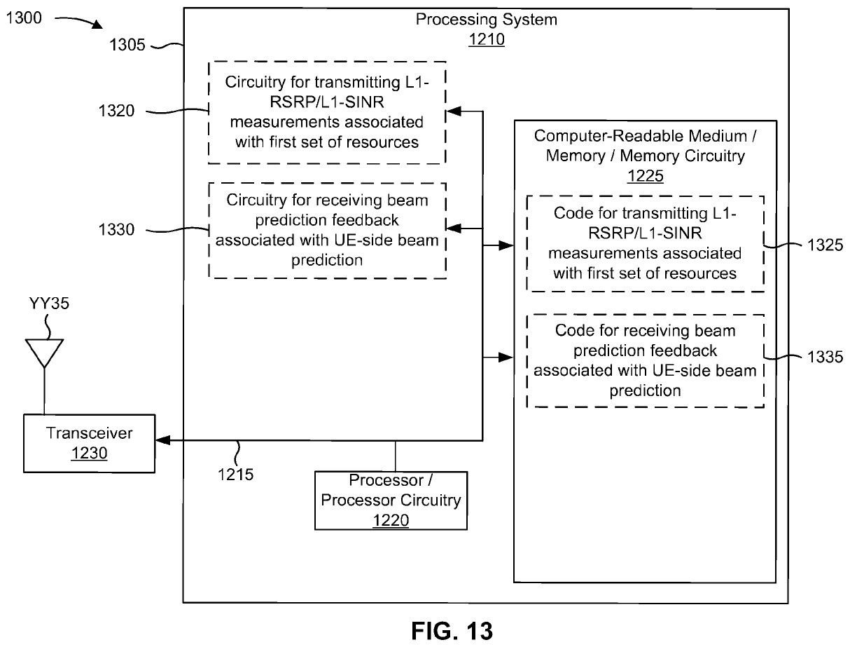

FIG. 13 is a diagram illustrating an example 1300 of an implementation of code and circuitry for an apparatus 1305, in accordance with the present disclosure. The circuity may include processing circuitry and memory circuitry. The apparatus 1305 may be a TE, or a TE may include the apparatus 1305.

As shown in FIG. 13, the apparatus 1305 may include circuitry for transmitting L1-RSRP/L1-SINR measurements associated with a first set of resources, wherein the L1-RSRP/L1-SINR measurements associated with the first set of resources are based at least in part on a generative model for test data that uses a randomization parameter (circuitry 1320). For example, the circuitry 1320 may enable the apparatus 1305 to transmit L1-RSRP/L1-SINR measurements associated with a first set of resources, wherein the L1-RSRP/L1-SINR measurements associated with the first set of resources are based at least in part on a generative model for test data that uses a randomization parameter.

As shown in FIG. 13, the apparatus 1305 may include, stored in computer-readable medium 1225, code for transmitting L1-RSRP/L1-SINR measurements associated with a first set of resources, wherein the L1-RSRP/L1-SINR measurements associated with the first set of resources are based at least in part on a generative model for test data that uses a randomization parameter (code 1325). For example, the code 1325, when executed by processor 1220, may cause processor 1220 to cause transceiver 1230 to transmit L1-RSRP/L1-SINR measurements associated with a first set of resources, wherein the L1-RSRP/L1-SINR measurements associated with the first set of resources are based at least in part on a generative model for test data that uses a randomization parameter.

As shown in FIG. 13, the apparatus 1305 may include circuitry for receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources (circuitry 1330). For example, the circuitry 1330 may enable the apparatus 1305 to receive, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources.

As shown in FIG. 13, the apparatus 1305 may include, stored in computer-readable medium 1225, code for receiving, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources (code 1335). For example, the code 1335, when executed by processor 1220, may cause processor 1220 to cause transceiver 1230 to receive, based at least in part on the L1-RSRP/L1-SINR measurements associated with the first set of resources, a beam prediction feedback associated with a UE-side beam prediction, wherein the beam prediction feedback indicates L1-RSRP/L1-SINR measurements associated with a second set of resources.

FIG. 13 is provided as an example. Other examples may differ from what is described in connection with FIG. 13.

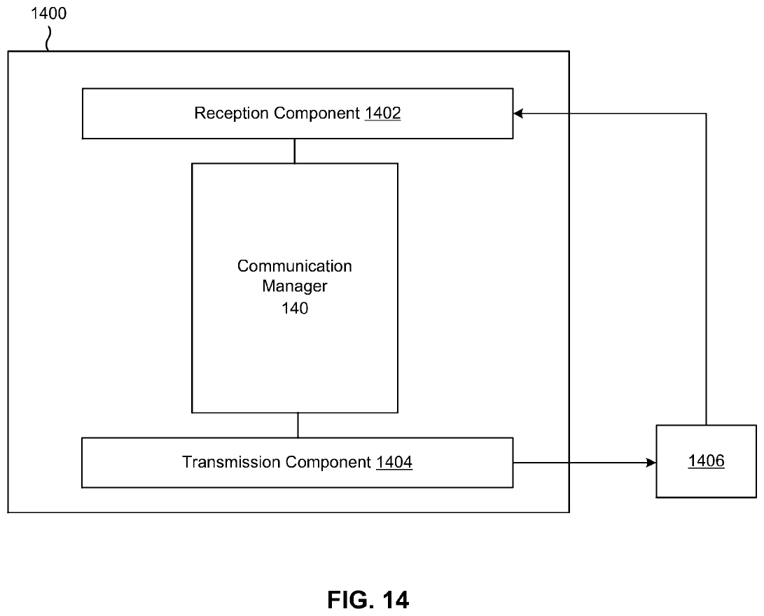

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140.

In some aspects, the apparatus 1400 may be configured to perform one or more operations described herein in connection with FIGS. 5-8. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1404 may be co-located with the reception component 1402 in one or more transceivers.

The reception component 1402 may receive L1-RSRP/L1-SINR measurements associated with a first set of resources, wherein the L1-RSRP/L1-SINR measurements associated with the first set of resources are based at least in part on a generative model for test data that uses a randomization parameter. The transmission component 1404 may transmit, based at least in part on the L1-RSRP/L1-SINR measurements associated with the first set of resources, a beam prediction feedback indicating L1-RSRP/L1-SINR measurements associated with a second set of resources.

The reception component 1402 may receive an indication of associations between the first set of resources and the second set of resources, wherein the indication indicates one or more of a QCL, a relative beam pointing direction, a relative beamwidth, an absolute beam point direction, or an absolute beamwidth. The reception component 1402 may receive an indication of the randomization parameter used by the generative model for test data to generate the L1-RSRP/L1-SINR measurements associated with the first set of resources.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

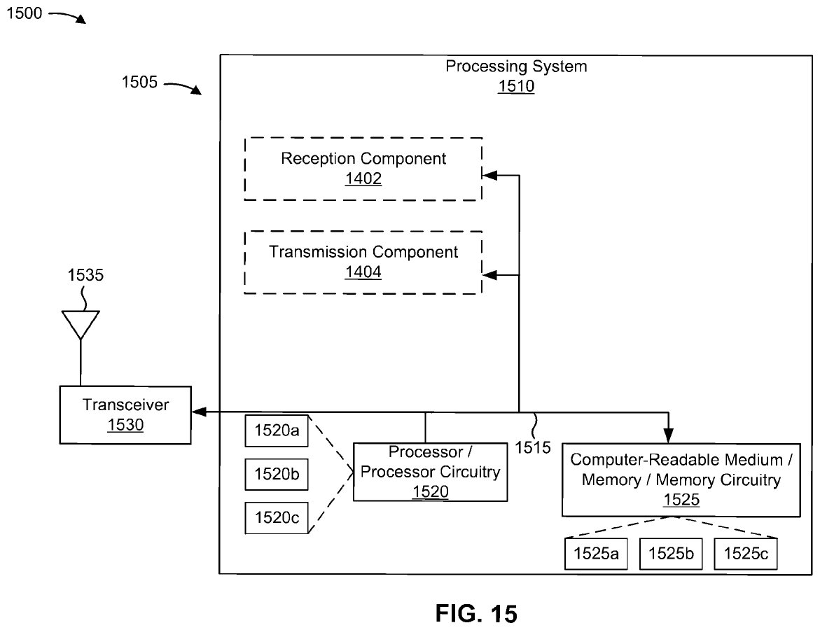

FIG. 15 is a diagram illustrating an example 1500 of a hardware implementation for an apparatus 1505 employing a processing system 1510, in accordance with the present disclosure. The apparatus 1505 may be a UE.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor (or processing circuitry) 1520, the illustrated components, and the computer-readable medium/memory (or memory circuitry) 1525. The processor 1520 may include multiple processors, such as processor 1520a, memory 1520b, and memory 1520c. The memory 1525 may include multiple memories, such as memory 1525a, memory 1525b, and memory 1525c. The bus 1515 may also link various other circuits, such as timing sources, peripherals, voltage regulators, and/or power management circuits.

The processing system 1510 may be coupled to a transceiver 1530. The transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes a processor 1520 coupled to a computer-readable medium/memory 1525. The processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software.

The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the UE 120 and may include the memory 282 and/or at least one of the TX MIMO processor 266, the Rx processor 258, and/or the controller/processor 280. In some aspects, the apparatus 1505 for wireless communication includes means for receiving L1-RSRP/L1-SINR measurements associated with a first set of resources, wherein the L1-RSRP/L1-SINR measurements associated with the first set of resources are based at least in part on a generative model for test data that uses a randomization parameter; and/or means for transmitting, based at least in part on the L1-RSRP/L1-SINR measurements associated with the first set of resources, a beam prediction feedback indicating L1-RSRP/L1-SINR measurements associated with a second set of resources. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the TX MIMO processor 266, the Rx processor 258, and/or the controller/processor 280. In one configuration, the aforementioned means may be the TX MIMO processor 266, the Rx processor 258, and/or the controller/processor 280 configured to perform the functions and/or operations recited herein.

FIG. 15 is provided as an example. Other examples may differ from what is described in connection with FIG. 15.

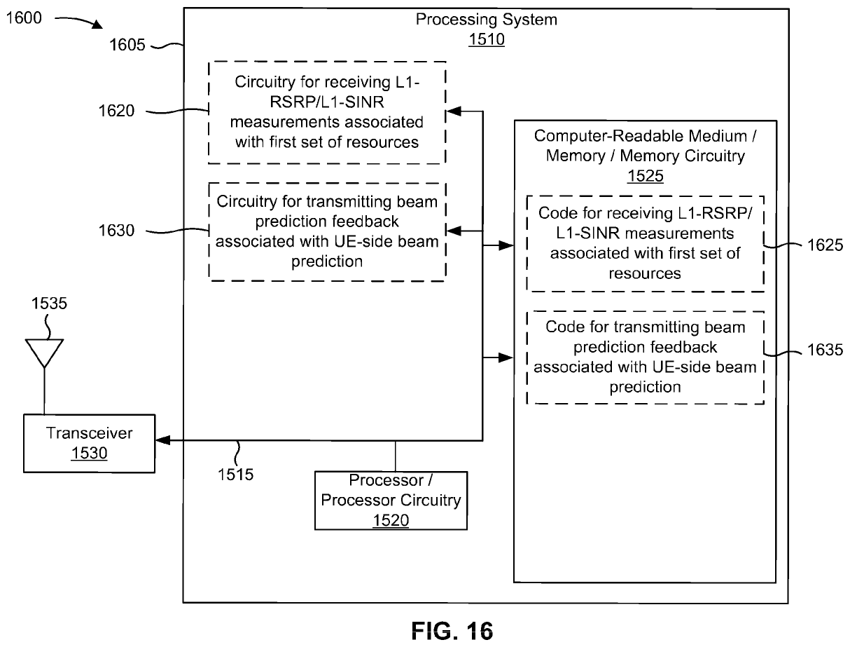

FIG. 16 is a diagram illustrating an example 1600 of an implementation of code and circuitry for an apparatus 1605, in accordance with the present disclosure. The circuity may include processing circuitry and memory circuitry. The apparatus 1605 may be a UE, or a UE may include the apparatus 1605.

As shown in FIG. 16, the apparatus 1605 may include circuitry for receiving L1-RSRP/L1-SINR measurements associated with a first set of resources, wherein the L1-RSRP/L1-SINR measurements associated with the first set of resources are based at least in part on a generative model for test data that uses a randomization parameter (circuitry 1620). For example, the circuitry 1620 may enable the apparatus 1605 to receive L1-RSRP/L1-SINR measurements associated with a first set of resources, wherein the L1-RSRP/L1-SINR measurements associated with the first set of resources are based at least in part on a generative model for test data that uses a randomization parameter.

As shown in FIG. 16, the apparatus 1605 may include, stored in computer-readable medium 1525, code for receiving L1-RSRP/L1-SINR measurements associated with a first set of resources, wherein the L1-RSRP/L1-SINR measurements associated with the first set of resources are based at least in part on a generative model for test data that uses a randomization parameter (code 1625). For example, the code 1625, when executed by processor 1520, may cause processor 1520 to cause transceiver 1530 to receive L1-RSRP/L1-SINR measurements associated with a first set of resources, wherein the L1-RSRP/L1-SINR measurements associated with the first set of resources are based at least in part on a generative model for test data that uses a randomization parameter.

As shown in FIG. 16, the apparatus 1605 may include circuitry for transmitting, based at least in part on the L1-RSRP/L1-SINR measurements associated with the first set of resources, a beam prediction feedback indicating L1-RSRP/L1-SINR measurements associated with a second set of resources (circuitry 1630). For example, the circuitry 1630 may enable the apparatus 1605 to transmit, based at least in part on the L1-RSRP/L1-SINR measurements associated with the first set of resources, a beam prediction feedback indicating L1-RSRP/L1-SINR measurements associated with a second set of resources.

As shown in FIG. 16, the apparatus 1605 may include, stored in computer-readable medium 1525, code for transmitting, based at least in part on the L1-RSRP/L1-SINR measurements associated with the first set of resources, a beam prediction feedback indicating L1-RSRP/L1-SINR measurements associated with a second set of resources (code 1635). For example, the code 1635, when executed by processor 1520, may cause processor 1520 to cause transceiver 1530 to transmit, based at least in part on the L1-RSRP/L1-SINR measurements associated with the first set of resources, a beam prediction feedback indicating L1-RSRP/L1-SINR measurements associated with a second set of resources.

FIG. 16 is provided as an example. Other examples may differ from what is described in connection with FIG. 16.

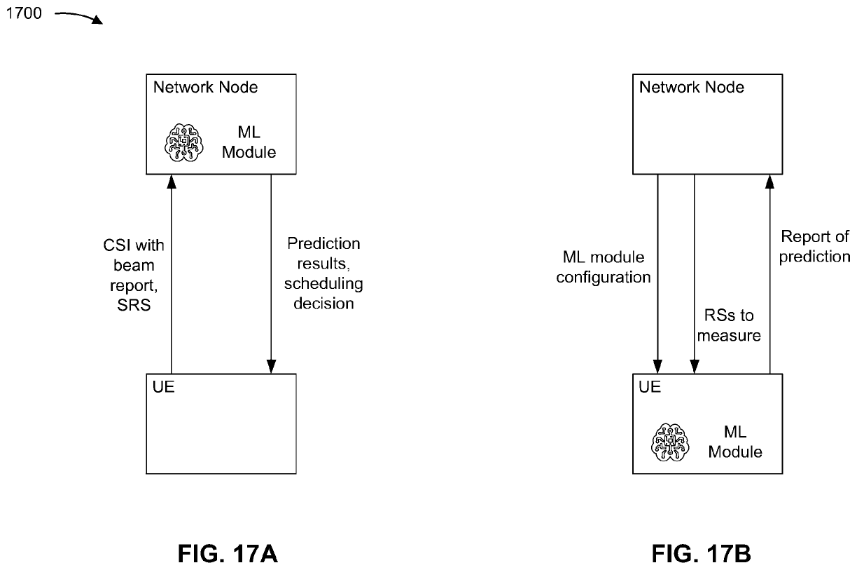

FIGS. 17A and 17B are diagrams illustrating examples 1700 of ML models for beam prediction, in accordance with the present disclosure.

As shown by FIG. 17A, an ML model for beam prediction may run at a network node. A UE may feed back CSI with a beam report. The UE may feed back a sounding reference signal (SRS). The network node may run the ML model for beam prediction based at least in part on feedback received from the UE. The network node may determine a beam prediction result using the ML model for beam prediction. The network node may perform a scheduling decision for the UE based at least in part on the beam prediction result. The ML model for beam prediction may be run at the network node when the UE is power and/or computation power limited.

As shown by FIG. 17B, an ML model for beam prediction may be run at a UE. The ML model for beam prediction may be configured by a network node. The UE may run the ML model for beam prediction based at least in part on local measurements and signaling from the network node. The UE may report, to the network node, a beam prediction result based at least in part on a configuration or triggering condition. The UE may run the ML model for beam prediction because the UE may generally have more measurement results, as compared to the network node, and running the ML model for beam prediction at the UE may involve less overhead for reporting.

However, running the ML model for beam prediction at the UE may involve a higher computation capability at the UE.

As indicated above, 17A and 17B are provided as examples. Other examples may differ from what is described with regard to FIGS. 17A and 17B.

The following provides an overview of some Aspects of the present disclosure:
Aspect 1: A method of wireless communication performed at a test equipment (TE), comprising: transmitting layer 1 (L1) reference signal received power (RSRP) or L1 signal-to-interference-plus-noise ratio (SINR) (L1-RSRP/L1-SINR) measurements associated with a first set of resources, wherein the L1-RSRP/L1-SINR measurements associated with the first set of resources are based at least in part on a generative model for test data that uses a randomization parameter; and receiving, based at least in part on the L1-RSRP/L1-SINR measurements associated with the first set of resources, a beam prediction feedback associated with a user equipment (UE)-side beam prediction, wherein the beam prediction feedback indicates L1-RSRP/L1-SINR measurements associated with a second set of resources.
Aspect 2: The method of Aspect 1, further comprising: generating, based at least in part on the generative model for test data, the L1-RSRP/L1-SINR measurements associated with the first set of resources based at least in part on the randomization parameter.
Aspect 3: The method of any of Aspects 1-2, wherein the generative model for test data or parameters associated with the generative model for test data are at least partially defined in a Third Generation Partnership Project (3GPP) specification.
Aspect 4: The method of any of Aspects 1-3, further comprising: generating, based at least in part on the generative model for test data, reproduced L1-RSRP/L1-SINR measurements associated with the second set of resources; and determining, based at least in part on a comparison of the reproduced L1-RSRP/L1-SINR measurements associated with the second set of resources and the L1-RSRP/L1-SINR measurements associated with the second set of resources, an accuracy of the UE-side beam prediction.
Aspect 5: The method of any of Aspects 1-4, further comprising: transmitting an indication of associations between the first set of resources and the second set of resources, wherein the indication indicates one or more of a quasi co-location (QCL), a relative beam pointing direction, a relative beamwidth, an absolute beam point direction, or an absolute beamwidth.
Aspect 6: The method of any of Aspects 1-5, wherein: the L1-RSRP/L1-SINR measurements associated with the first set of resources are transmitted via a cable between the TE and a UE; and the L1-RSRP/L1-SINR measurements associated with the second set of resources are received via the cable or via an air interface between the TE and the UE.
Aspect 7: The method of any of Aspects 1-6, wherein the first set of resources and the second set of resources are non-overlapping based at least in part on the L1-RSRP/L1-SINR measurements associated with the first set of resources and the L1-RSRP/L1-SINR measurements associated with the second set of resources being associated with a same time domain occasion.
Aspect 8: The method of any of Aspects 1-7, wherein the first set of resources and the second set of resources overlap based at least in part on the L1-RSRP/L1-SINR measurements associated with the second set of resources being associated with a future time domain occasion.
Aspect 9: The method of any of Aspects 1-8, wherein the generative model for test data is defined based at least in part on an analytical expression or a statistical expression, and with the randomization parameter that is able to be varied by the TE.
Aspect 10: The method of any of Aspects 1-9, wherein the randomization parameter is associated with one of: a network node antenna configuration, a delay spread, an indoor environment, an outdoor environment, an urban environment, a rural environment, a cell type, a Doppler shift, or a UE speed.
Aspect 11: The method of any of Aspects 1-10, further comprising: transmitting an indication of the randomization parameter used by the generative model for test data to generate the L1-RSRP/L1-SINR measurements associated with the first set of resources.
Aspect 12: The method of any of Aspects 1-11, wherein the generative model for test data is defined based at least in part on an artificial intelligence (AI) or machine learning (ML) (AI/ML) model, an AI/ML model input includes the randomization parameter, and the AI/ML model input is able to be varied by the TE.
Aspect 13: The method of any of Aspects 1-12, wherein the L1-RSRP/L1-SINR measurements associated with the first set of resources include a first portion of L1-RSRP/L1-SINR measurements and a second portion of L1-RSRP/L1-SINR measurements.
Aspect 14: The method of Aspect 13, wherein the first portion of L1-RSRP/L1-SINR measurements and the second portion of L1-RSRP/L1-SINR measurements are associated with the generative model for test data that is defined based at least in part on an analytical expression or a statistical expression.
Aspect 15: The method of Aspect 13, wherein the first portion of L1-RSRP/L1-SINR measurements and the second portion of L1-RSRP/L1-SINR measurements are associated with the generative model for test data that is defined based at least in part on an artificial intelligence (AI) or machine learning (ML) (AI/ML) model.
Aspect 16: The method of Aspect 13, wherein the first portion of L1-RSRP/L1-SINR measurements are associated with the generative model for test data that is defined based at least in part on an analytical expression or a statistical expression, and the second portion of L1-RSRP/L1-SINR measurements are associated with the generative model for test data that is defined based at least in part on an artificial intelligence (AI) or machine learning (ML) (AI/ML) model.
Aspect 17: The method of any of Aspects 1-5416 wherein the L1-RSRP/L1-SINR measurements associated with the first set of resources and reproduced L1-RSRP/L1-SINR measurements associated with the second set of resources are associated with the randomization parameter.
Aspect 18: The method of any of Aspects 1-17, wherein reproduced L1-RSRP/L1-SINR measurements associated with the second set of resources are associated with multiple future time domain occasions, and the multiple future time domain occasions are associated with a same prediction instance.
Aspect 19: The method of Aspect 18, wherein a first randomization parameter associated with a first time domain occasion, of the multiple future time domain occasions, corresponds to a second randomization parameter associated with a second time domain occasion, of the multiple future time domain occasions.
Aspect 20: The method of any of Aspects 1-19, wherein the L1-RSRP/L1-SINR measurements associated with the first set of resources are associated with one or more historical time domain occasions, and the L1-RSRP/L1-SINR measurements associated with the first set of resources are based at least in part on a change in the randomization parameter across the one or more historical time domain occasions.
Aspect 21: A method of wireless communication performed at a user equipment (UE), comprising: receiving layer 1 (L1) reference signal received power (RSRP) or L1 signal-to-interference-plus-noise ratio (SINR) (L1-RSRP/L1-SINR) measurements associated with a first set of resources, wherein the L1-RSRP/L1-SINR measurements associated with the first set of resources are based at least in part on a generative model for test data that uses a randomization parameter; and transmitting, based at least in part on the L1-RSRP/L1-SINR measurements associated with the first set of resources, a beam prediction feedback indicating L1-RSRP/L1-SINR measurements associated with a second set of resources.
Aspect 22: The method of Aspect 21, wherein the generative model for test data or parameters associated with the generative model for test data are at least partially defined in a Third Generation Partnership Project (3GPP) specification.
Aspect 23: The method of any of Aspects 21-22, further comprising: receiving an indication of associations between the first set of resources and the second set of resources, wherein the indication indicates one or more of a quasi co-location (QCL), a relative beam pointing direction, a relative beamwidth, an absolute beam point direction, or an absolute beamwidth.
Aspect 24: The method of any of Aspects 21-23, wherein: the L1-RSRP/L1-SINR measurements associated with the first set of resources are received via a cable between the UE and a test equipment (TE); and the L1-RSRP/L1-SINR measurements associated with the second set of resources are transmitted via the cable or via an air interface between the UE and the TE.
Aspect 25: The method of any of Aspects 21-24, wherein the first set of resources and the second set of resources are non-overlapping based at least in part on the L1-RSRP/L1-SINR measurements associated with the first set of resources and the L1-RSRP/L1-SINR measurements associated with the second set of resources being associated with a same time domain occasion.
Aspect 26: The method of any of Aspects 21-25, wherein the first set of resources and the second set of resources overlap based at least in part on the L1-RSRP/L1-SINR measurements associated with the second set of resources being associated with a future time domain occasion.
Aspect 27: The method of any of Aspects 21-26, wherein the generative model for test data is defined based at least in part on an analytical expression or a statistical expression, and with the randomization parameter that is variable.
Aspect 28: The method of any of Aspects 21-27, wherein the randomization parameter is associated with one of: a network node antenna configuration, a delay spread, an indoor environment, an outdoor environment, an urban environment, a rural environment, a cell type, a Doppler shift, or a UE speed.
Aspect 29: The method of any of Aspects 21-28, further comprising: receiving an indication of the randomization parameter used by the generative model for test data to generate the L1-RSRP/L1-SINR measurements associated with the first set of resources.
Aspect 30: The method of any of Aspects 21-29, wherein the generative model for test data is defined based at least in part on an artificial intelligence (AI) or machine learning (ML) (AI/ML) model, an AI/ML model input includes the randomization parameter, and the AI/ML model input is variable.
Aspect 31: The method of any of Aspects 21-30, wherein the L1-RSRP/L1-SINR measurements associated with the first set of resources include a first portion of L1-RSRP/L1-SINR measurements and a second portion of L1-RSRP/L1-SINR measurements.
Aspect 32: The method of Aspect 31, wherein the first portion of L1-RSRP/L1-SINR measurements and the second portion of L1-RSRP/L1-SINR measurements are associated with the generative model for test data that is defined based at least in part on an analytical expression or a statistical expression.
Aspect 33: The method of Aspect 31, wherein the first portion of L1-RSRP/L1-SINR measurements and the second portion of L1-RSRP/L1-SINR measurements are associated with the generative model for test data that is defined based at least in part on an artificial intelligence (AI) or machine learning (ML) (AI/ML) model.
Aspect 34: The method of Aspect 31, wherein the first portion of L1-RSRP/L1-SINR measurements are associated with the generative model for test data that is defined based at least in part on an analytical expression or a statistical expression, and the second portion of L1-RSRP/L1-SINR measurements are associated with the generative model for test data that is defined based at least in part on an artificial intelligence (AI) or machine learning (ML) (AI/ML) model.
Aspect 35: The method of any of Aspects 21-34, wherein the L1-RSRP/L1-SINR measurements associated with the first set of resources and reproduced L1-RSRP/L1-SINR measurements associated with the second set of resources are associated with the randomization parameter.
Aspect 36: The method of any of Aspects 21-35, wherein reproduced L1-RSRP/L1-SINR measurements associated with the second set of resources are associated with multiple future time domain occasions, and the multiple future time domain occasions are associated with a same prediction instance.
Aspect 37: The method of Aspect 36, wherein a first randomization parameter associated with a first time domain occasion, of the multiple future time domain occasions, corresponds to a second randomization parameter associated with a second time domain occasion, of the multiple future time domain occasions.
Aspect 38: The method of any of Aspects 21-37, wherein the L1-RSRP/L1-SINR measurements associated with the first set of resources are associated with one or more historical time domain occasions, and the L1-RSRP/L1-SINR measurements associated with the first set of resources are based at least in part on a change in the randomization parameter across the one or more historical time domain occasions.
Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.
Aspect 40: An apparatus for wireless communication at a device, the apparatus comprising one or more memories and one or more processors coupled to the one or more memories, the one or more processors configured to cause the device to perform the method of one or more of Aspects 1-20.
Aspect 41: An apparatus for wireless communication, the apparatus comprising at least one means for performing the method of one or more of Aspects 1-20.
Aspect 42: A non-transitory computer-readable medium storing code for wireless communication, the code comprising instructions executable by one or more processors to perform the method of one or more of Aspects 1-20.
Aspect 43: A non-transitory computer-readable medium storing a set of instructions for wireless communication, the set of instructions comprising one or more instructions that, when executed by one or more processors of a device, cause the device to perform the method of one or more of Aspects 1-20.
Aspect 44: A device for wireless communication, the device comprising a processing system that includes one or more processors and one or more memories coupled with the one or more processors, the processing system configured to cause the device to perform the method of one or more of Aspects 1-20.
Aspect 45: A test equipment (TE) for wireless communication, comprising: a processing system that includes processor circuitry and memory circuitry that stores code and is coupled with the processor circuitry, the processing system configured to cause the TE to perform the method of one or more of Aspects 1-20.
Aspect 46: An apparatus for wireless communication at a test equipment (TE), the apparatus comprising one or more memories and one or more processors coupled to the one or more memories, the one or more processors configured to individually or collectively cause the TE to perform the method of one or more of Aspects 1-20.
Aspect 47: An apparatus for wireless communication at a test equipment (TE), comprising: a processing system that includes processor circuitry and memory circuitry that stores code and is coupled with the processor circuitry, the processing system configured to cause the TE to perform the method of one or more of Aspects 1-20.
Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 21-28.
Aspect 49: An apparatus for wireless communication at a device, the apparatus comprising one or more memories and one or more processors coupled to the one or more memories, the one or more processors configured to cause the device to perform the method of one or more of Aspects 21-28.
Aspect 50: An apparatus for wireless communication, the apparatus comprising at least one means for performing the method of one or more of Aspects 21-28.
Aspect 51: A non-transitory computer-readable medium storing code for wireless communication, the code comprising instructions executable by one or more processors to perform the method of one or more of Aspects 21-28.
Aspect 52: A non-transitory computer-readable medium storing a set of instructions for wireless communication, the set of instructions comprising one or more instructions that, when executed by one or more processors of a device, cause the device to perform the method of one or more of Aspects 21-28.
Aspect 53: A device for wireless communication, the device comprising a processing system that includes one or more processors and one or more memories coupled with the one or more processors, the processing system configured to cause the device to perform the method of one or more of Aspects 21-28.
Aspect 54: A user equipment (UE) for wireless communication, comprising: a processing system that includes processor circuitry and memory circuitry that stores code and is coupled with the processor circuitry, the processing system configured to cause the UE to perform the method of one or more of Aspects 21-28.
Aspect 55: An apparatus for wireless communication at a user equipment (UE), the apparatus comprising one or more memories and one or more processors coupled to the one or more memories, the one or more processors configured to individually or collectively cause the UE to perform the method of one or more of Aspects 21-28.
Aspect 56: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 21-28.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b +c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a test equipment (TE), comprising:
one or more memories; and
one or more processors coupled with the one or more memories and configured to cause the TE to:
transmit layer 1 (L1) reference signal received power (RSRP) or L1 signal-to-interference-plus-noise ratio (SINR) (L1-RSRP/L1-SINR) measurements associated with a first set of resources, wherein the L1-RSRP/L1-SINR measurements associated with the first set of resources are based at least in part on a generative model for test data that uses a randomization parameter; and
receive, based at least in part on the L1-RSRP/L1-SINR measurements associated with the first set of resources, a beam prediction feedback associated with a user equipment (UE)-side beam prediction, wherein the beam prediction feedback indicates L1-RSRP/L1-SINR measurements associated with a second set of resources.

2. The apparatus of claim 1, wherein the one or more processors are further configured to cause the TE to:
generate, based at least in part on the generative model for test data, the L1-RSRP/L1-SINR measurements associated with the first set of resources based at least in part on the randomization parameter.

3. The apparatus of claim 1, wherein the generative model for test data or parameters associated with the generative model for test data are at least partially defined in a Third Generation Partnership Project (3GPP) specification.

4. The apparatus of claim 1, wherein the one or more processors are further configured to cause the TE to:
generate, based at least in part on the generative model for test data, reproduced L1-RSRP/L1-SINR measurements associated with the second set of resources; and
determine, based at least in part on a comparison of the reproduced L1-RSRP/L1-SINR measurements associated with the second set of resources and the L1-RSRP/L1-SINR measurements associated with the second set of resources, an accuracy of the UE-side beam prediction.

5. The apparatus of claim 1, wherein the one or more processors are further configured to cause the TE to:
transmit an indication of associations between the first set of resources and the second set of resources, wherein the indication indicates one or more of a quasi co-location (QCL), a relative beam pointing direction, a relative beamwidth, an absolute beam point direction, or an absolute beamwidth.

6. The apparatus of claim 1, wherein:
the L1-RSRP/L1-SINR measurements associated with the first set of resources are transmitted via a cable between the TE and a UE; and
the L1-RSRP/L1-SINR measurements associated with the second set of resources are received via the cable or via an air interface between the TE and the UE.

7. The apparatus of claim 1, wherein the first set of resources and the second set of resources are non-overlapping based at least in part on the L1-RSRP/L1-SINR measurements associated with the first set of resources and the L1-RSRP/L1-SINR measurements associated with the second set of resources being associated with a same time domain occasion.

8. The apparatus of claim 1, wherein the first set of resources and the second set of resources overlap based at least in part on the L1-RSRP/L1-SINR measurements associated with the second set of resources being associated with a future time domain occasion.

9. The apparatus of claim 1, wherein the generative model for test data is defined based at least in part on an analytical expression or a statistical expression, and with the randomization parameter that is able to be varied by the TE.

10. The apparatus of claim 1, wherein the randomization parameter is associated with one of: a network node antenna configuration, a delay spread, an indoor environment, an outdoor environment, an urban environment, a rural environment, a cell type, a Doppler shift, or a UE speed.

11. The apparatus of claim 1, wherein the one or more processors are further configured to cause the TE to:
transmit an indication of the randomization parameter used by the generative model for test data to generate the L1-RSRP/L1-SINR measurements associated with the first set of resources.

12. The apparatus of claim 1, wherein the generative model for test data is defined based at least in part on an artificial intelligence (AI) or machine learning (ML) (AI/ML) model, an AI/ML model input includes the randomization parameter, and the AI/ML model input is able to be varied by the TE.

13. The apparatus of claim 1, wherein the L1-RSRP/L1-SINR measurements associated with the first set of resources include a first portion of L1-RSRP/L1-SINR measurements and a second portion of L1-RSRP/L1-SINR measurements.

14.-16. (canceled)

17. The apparatus of claim 1, wherein the L1-RSRP/L1-SINR measurements associated with the first set of resources and reproduced L1-RSRP/L1-SINR measurements associated with the second set of resources are associated with the randomization parameter.

18. The apparatus of claim 1, wherein reproduced L1-RSRP/L1-SINR measurements associated with the second set of resources are associated with multiple future time domain occasions, and the multiple future time domain occasions are associated with a same prediction instance.

19. (canceled)

20. The apparatus of claim 1, wherein the L1-RSRP/L1-SINR measurements associated with the first set of resources are associated with one or more historical time domain occasions, and the L1-RSRP/L1-SINR measurements associated with the first set of resources are based at least in part on a change in the randomization parameter across the one or more historical time domain occasions.

21. An apparatus for wireless communication at a user equipment (UE), comprising:
one or more memories; and
one or more processors coupled with the one or more memories and configured to cause the UE to:
receive layer 1 (L1) reference signal received power (RSRP) or L1 signal-to-interference-plus-noise ratio (SINR) (L1-RSRP/L1-SINR) measurements associated with a first set of resources, wherein the L1-RSRP/L1-SINR measurements associated with the first set of resources are based at least in part on a generative model for test data that uses a randomization parameter; and
transmit, based at least in part on the L1-RSRP/L1-SINR measurements associated with the first set of resources, a beam prediction feedback indicating L1-RSRP/L1-SINR measurements associated with a second set of resources.

22. The apparatus of claim 21, wherein the one or more processors are further configured to cause the UE to:
receive an indication of associations between the first set of resources and the second set of resources, wherein the indication indicates one or more of a quasi co-location (QCL), a relative beam pointing direction, a relative beamwidth, an absolute beam point direction, or an absolute beamwidth.

23. The apparatus of claim 21, wherein:
the L1-RSRP/L1-SINR measurements associated with the first set of resources are received via a cable between the UE and a test equipment (TE); and
the L1-RSRP/L1-SINR measurements associated with the second set of resources are transmitted via the cable or via an air interface between the UE and the TE.

24. The apparatus of claim 21, wherein:
the first set of resources and the second set of resources are non-overlapping based at least in part on the L1-RSRP/L1-SINR measurements associated with the first set of resources and the L1-RSRP/L1-SINR measurements associated with the second set of resources being associated with a same time domain occasion; or
the first set of resources and the second set of resources overlap based at least in part on the L1-RSRP/L1-SINR measurements associated with the second set of resources being associated with a future time domain occasion.

25.-30. (canceled)
